(19) United States
(12) Patent Application Publication
(10) Pub. No.: US 2025/0287204 A1
(43) Pub. Date: Sep. 11, 2025

(54) AUTHENTICATION CIRCUIT

(71) Applicant: Benjamin Firooz Ghassabian, Toulon (FR)

(72) Inventor: Benjamin Firooz Ghassabian, Toulon (FR)

(21) Appl. No.: 18/762,025

(22) PCT Filed: Jan. 20, 2023
(86) PCT No.: PCT/IB2023/000027

§ 371 Date: Jul. 2, 2024

Related U.S. Application Data
(60) Provisional application No. 63/302,704, filed on Jan. 25, 2022.
(60) Provisional application No. 63/306,296, filed on Feb. 3, 2022.
(60) Provisional application No. 63/309,589, filed on Feb. 13, 2022.
(60) Provisional application No. 63/399,697, filed on Aug. 21, 2022.

(51) Int. Cl. H04W 12/062; H04W 12/0433

(52) U.S. Cl. CPC H04W 12/062; H04W 12/0433

(57) ABSTRACT

An access control system including an authentication circuit comprising for permitting an access to a user's account in a server. The system uses an application installed within a number of communication devices within said circuit. Upon accomplishment of a communication circuit between said devices, an authentication procedure is completed and an access to said account is granted to a user.

### FIELD OF THE INVENTION

This application claims priority under 35 USC .sctn.119(e) to U.S. Provisional Patent Application Ser. No. 63/302,704, filed 25 Jan. 2022, U.S. Provisional Patent Application Ser. No. 63/306,296, filed 3 Feb. 2022, U.S. Provisional Patent Application Ser. No. 63/309,589, filed 13Feb. 2022 and U.S. Provisional Patent Application Ser. No. 63/399,697, filed 21 Aug. 2022, the entire contents of which are hereby incorporated by reference.

The following explains several embodiments with reference to the drawings. Each embodiment may have a portion corresponding to that of a precedent embodiment; such a portion is assigned with an identical reference number so as to omit overlapped explanation. When only a portion of the configuration of each embodiment is explained, the other portions of the configuration may adopt those of the precedent embodiment previously explained. Partial combination between the embodiments may be possible with respect to not only a portion which is explicitly described in each embodiment, but also a portion which is not explicitly described.

This patent application is mainly related to solving the major problem of the communication market, which is how to execute a highly secured log-in process, without using a password, for entering into a (e.g. existing) protected account within/controlled-by a local computer and/or within/controlled-by a remote (e.g., in the cloud) virtual and/or physical computing device (e.g., a server of a bank, a server of an insurance company, a healthcare website, an online shopping website, an online payment website such as PayPal, or within any other software requiring authentication of an identification, etc.) in a highly secured manner. Such server may, herein, be referred to as an “account server”.

### BACKGROUND OF THE INVENTION

A virtual content (e.g. data, software, etc.) can be locally located/stored within a computing device (e.g. PC, smartphone, etc.) or it may be remotely located/stored on/in a server. Some virtual contents are open to the public (e.g., herein may be referred to as “public content”), meaning that everyone person can access them without restriction (e.g., without requiring a password). On the other hand, some virtual contents are protected, meaning that access to said contents is restricted to authorized people (e.g., herein may be referred to as “protected content”). To access a protected account a user, generally, must provide some/a predefined identification information to the server containing/holding said protected account. For simplifying the specification of this patent application, a computing device and/or a server having/holding a (e.g., one or more) protected account may herein be referred to as an “account server”.

Passwords are used frequently for accessing protected contents. Users are often creating a different/new password for (e.g., creating and then) accessing a different/new protected content stored locally within a user's device and/or remotely within an account server.

Usually, a user creates a different password for accessing a different protected account. As such, a user may have one or more lists of tens or even hundreds of different passwords for tens or hundreds of protected accounts.

Many times a user does not have an access to a password (list) because it is out of the reach of the user at a specific time. For example, a (list of) password/s stored within a user's computing device and/or an accessory (e.g., a laptop, a smartphone, a tablet, a memory stick, etc.) or printed on paper, main remain at his/her home while the user is outside the home and, therefore, cannot connect to a protected account within an account server.

The above-explained reasons and more, makes the procedure of logging in to a protected account within a server, cumbersome, frustrating, time consuming and in some cases impossible. For logging in to a protected account, a user usually must look for a corresponding password within his/her device or within or on a paper where he usually stores or writes his/her (e.g. list of) passwords for saving them. Carrying a list of passwords one a computing device or on a paper is risky because it may be lost, stolen, being hacked by hackers or viewed accidentally to others.

In order to protect an account within an account server from being open/accessible to the general public and in order to restrict the access to said content to an (e.g., one or more) authorized person (e.g., only), a (e.g., one or more) (standard) access control system have been put in place in the industry. Said/an access control system usually consists of requires two steps:
Step 1: A Sign-in (e.g., registration) procedure for creating an access control system (e.g., to protect a corresponding user's account from being accessed by unauthorized people) requiring some information (e.g., such an identification keyword (e.g., a username), a password, user's telephone number, etc.) to be provided by the user to the corresponding account server. This step, is generally a mandatory step before/for being able to access/log in later to said account; and
Step 2: A log in (“log in”) procedure (e.g., for successfully bypassing/going through said access control system and accessing said (protected) account (e.g., for a user that has previously executed the sign-in procedure);

In step 1, a sign-in interface is presented to a user on a screen of a computing device by a corresponding protecting account server. A user is generally required to provide a number/plurality of identification information, such as an identifying text (e.g., user's social security number Herein may be referred to as user's ID), etc. (e.g., herein may be referred to as “Username”). In addition, the user is generally required to create and provide an arbitrary/desired password through said interface to the protecting account server.

In addition to the above, during a sign-in procedure, the user may also be required to provide additional information such as a contact information (e.g. telephone number (e.g., of a user's device), an email address, etc.) to which the protecting account server may send an information (e.g., herein may be referred to as a “security code”) during a log-in attempt (e.g., initiated by the user).

The information provided by user during the sign-in procedure, is then stored (e.g., in a database) within a memory of a/the account server.

Step 2, is processed every time said user desires to access said protected account. For accessing the protected account, a log-in interface is presented by the protected account server to a user on a screen of a computing device. A user is required to provide at least some of the information, including the password, that he/she has been provided (e.g., earlier) through the sign-in procedure. Upon providing the required information, an authentication software/procedure is executed (e.g., in the account server) to validate the authenticity of the information provided by the user. Upon validation, the user is given access (e.g., by the account server) to the protected content.

### SUMMARY OF THE INVENTION

The current invention is related to a system for accessing a protected account without using a password. For such purpose, an authentication system/procedure comprising a circuit of plurality of devices communicating with each other (e.g., herein may be referred to as “authentication circuit”) is considered/used. Said system may preferably include an application for controlling the communication between said devices (e.g., herein may be referred to as “controlling application”).

An authentication circuit may preferably include an account server having at least one protected account, and at least two devices: a) a first communication device (e.g., herein may be referred to as, a “main device”) used for accessing (e.g. for logging in to) said/a protected account, b) and at least a second communication device (e.g., herein may be referred to as, an intermediate device) to which said account server will send a security code during a/the log-in procedure as described before. Note that, in accordance with the current invention, the/a contact information (e.g., the telephone number) of said intermediate device is also required by a corresponding account server (e.g., and must be provided by the user signing-in) during a/the corresponding sign-in procedure.

It is understood that, depending on to which protected account a user desires to access at a different instance, an account server within a/said authentication circuit may vary. As an example, when a user attempts to access his/her bank account within the server of a first bank, the account server within the corresponding authentication circuit will preferably be the account server of said first bank, and when a user attempts to access to his/her bank account within a second bank, the account server within said corresponding authentication circuit will preferably be the account server of said second bank. Accordingly, as an example, when a user attempts to access his/her account within an online shopping store, the account server within the corresponding authentication circuit will preferably be the account server of said online shopping store.

An aspect of the invention is related to an authentication system using a serial communication network for accessing a protected account within/related-to an account server.

An aspect of the invention is related to an authentication system using a parallel communication network for accessing a protected account within/related-to an account server.

An aspect of the invention is related to an authentication system using a specific communication network for accessing a protected account within/related-to an account server.

An aspect of the invention is related to an authentication system using a serial communication network for automatically accessing a protected account within/related-to an account server, upon accomplishment a first condition.

An aspect of the invention is related to an authentication system using a serial communication network for automatically accessing a protected account within/related-to an account server, upon accomplishment a second condition.

An aspect of the invention is related to using an authentication circuit for executing a protected software.

An aspect of the invention is related to using an authentication circuit for executing a function. An aspect of the invention is related to using an authentication circuit for executing a physical function.

As mentioned, the current patent application is related to systems for establishing a highly secured log-in procedure for accessing a (e.g., an existing) protected account in a (e.g. remote, local) account server without using a password (e.g., such systems may herein be referred to as “authentication system”, “authentication procedure”, etc.)

It is important to note that before using an authentication system of the invention for accessing a protected account within an account server, the/a condition for accessing said protected account must have been defined/created (e.g., in advance) preferably through a sign-in procedure.

### BRIEF DESCRIPTION OF DRAWINGS

FIG. 1A shows a system of authentication for logging in to a protected account within an account server without the need of using a password, in accordance with an exemplary embodiment of the invention;

FIG. 1B shows a system for preventing a user to access a protected account within an account server (e.g., without using a password), in accordance with an exemplary embodiment of the invention;

FIG. 1C shows a system for preventing a user to access a protected account within an account server (e.g., without using a password), in accordance with an exemplary embodiment of the invention;

FIG. 2A shows a system of authentication for logging in to a protected account within an account server by using multiple devices, without the need using a password, in accordance with an exemplary embodiment of the invention;

FIGS. 2B-2C show two systems for preventing to logging in to a protected account within an account server without the need of using a password by using multiple devices, in accordance with an exemplary embodiment of the invention;

FIG. 3A shows a system for logging in to a protected account within an account server without the need of using a password by using multiple devices, in accordance with an exemplary embodiment of the invention;

FIG. 3B shows a system for preventing to logging in to a protected account within an account server without the need of using a password by using multiple devices, and a method of bypassing the prevention, in accordance with an exemplary embodiment of the invention;

FIG. 4A shows a system for logging in to a protected account within an account server without the need of using a password by using multiple devices, in accordance with an exemplary embodiment of the invention;

FIG. 4B shows a system for preventing to logging in to a protected account within an account server without the need of using a password by using multiple devices, in accordance with an exemplary embodiment of the invention;

FIG. 5A shows a system for logging in to a protected account within an account server without the need of using a password by using multiple devices, in accordance with an exemplary embodiment of the invention;

FIG. 5B shows a system for preventing to logging in to a protected account within an account server without the need of using a password by using multiple devices, in accordance with an exemplary embodiment of the invention;

FIGS. 6A to 6G, show exemplary controlling tables used by an application controlling different authentication procedures, in accordance with different embodiments of the invention;

FIG. 6H, shows an exemplary account server including a controlling table used by the controlling applications of authentication procedures, in accordance with a different embodiment of the invention;

FIGS. 7A-7C, show exemplary authentication procedures for online payment, in accordance with a different embodiment of the invention;

FIG. 8, shows an example of plurality of devices used in an authentication system for logging in to a protected account within an account server without the need of using a password, in accordance with an exemplary embodiment of the invention;

FIG. 9, shows an example of a system for providing emotion input of users watching a video and a corresponding graph, in accordance with an exemplary embodiment of the invention;

### DETAILED DESCRIPTION OF THE INVENTION

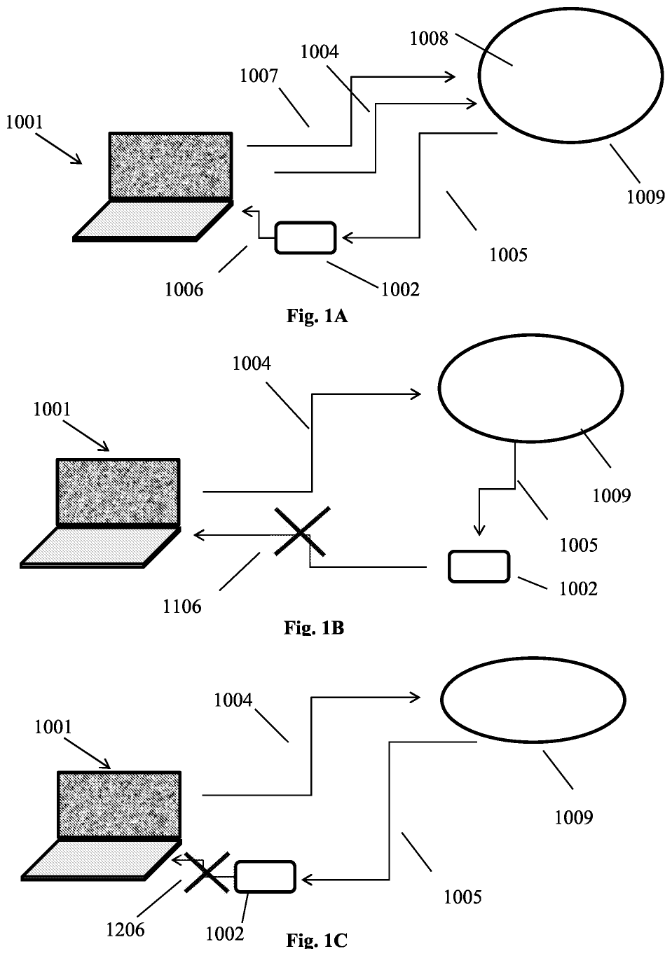

In accordance with one embodiment of the invention, FIG. 1A shows an exemplary authentication circuit comprising an account server 1009 and two additional communication devices 1001 and 1002. In this example, a first communication device 1001 is a laptop computer (e.g., or any other type of communication such as a smartphone, etc.). A user of (e.g., or a user controlling) the main device 1001 may wish to access an (e.g., his/her) protected account within an account server 1009 (e.g., such as a website of a bank, an online store, etc.), by using the main device 1001. The user may have/use a second communication device 1002 (e.g., an intermediate device, as described before), having a receiver and at least one transmitter for, respectfully, receiving and sending/transmitting signals/information/data. In this example, said intermediate device 1002 may preferably have and use a transmitter having (e.g., or be adjusted to have) a limited transmitting range (e.g., less than 10 meters, or less than 5 meters, or less than 1 meter, or less than 30 centimeters, less than 10 centimeters, etc.) (e.g. herein may be referred to as “short-range transmitter”). In order to receive an information/signals from the intermediate device, the main device 1001 may preferably be/should-be in the transmission range of (e.g., herein, may be referred to as, “close to/near”) the intermediate device 1002. According to one aspect, when said devices are closed to each other, communication between said devices may, preferably automatically, be established. According to another aspect, when said devices are closed to each other, communication between said devices may be established upon (e.g., manually) pairing said devices.

In order to access his/her protected account (e.g., without a password), a user controlling the main device 1001, at first may preferably open the log in webpage of a corresponding account server, on the (e.g. screen of the) main device 1001. Then, through said main device, the user may send 1004 a (e.g. at least one) predefined information (e.g. an email address, an identification number, etc., provided, previously, during the/a corresponding sign-in procedure) required by the account server 1009 for logging in to his/her protected account, to the corresponding account server 1009. Upon accomplishment of a condition (e.g., after verifying and validating said information by the account server 1009), the account server 1009 may preferably transmit/send 1005 a second information (e.g., a random and/or a predefined and/or a calculated security code/password, etc., which herein may be referred to as, “a security code”) to the intermediate device 1002. Preferably, said security code is sent in an encrypted manner. An encryption key/code may be used for encrypting the security code (e.g., by the account server). In this case, simultaneously or under accomplishment of a condition, a decryption key/code (e.g., herein may be referred to as “decryption/decrypting key”) for decrypting said encrypted security code is preferably sent by, preferably, the account server 1009 to the main device 1001. (e.g., optionally, the encrypted security code is sent to the main device and the decrypting key is sent to the intermediate device). Upon receiving said security code by the intermediate device 1002, said intermediate device 1002 may preferably automatically transmit 1006 said security code (e.g., or another security code in relation to/based on said security code) to the main device 1001. Note that, a decryption key/code is, generally/preferably/always, the same/similar key/code used for encrypting a/said security code.

According to one embodiment, the decryption key is sent by the account server to the main device after accomplishment of a condition such as after the/a corresponding encrypted security code (e.g., received by an intermediate device (e.g., from the account server)) is sent by the/an intermediate device to a/the corresponding main device. According to another embodiment, the decryption key is sent by the account server to the main device after accomplishment of a condition such as after the/a corresponding encrypted security code (e.g., sent by the account server to an intermediate device) is received by/in the main device (e.g., from the/an intermediate device). In the current embodiments, the account server is preferably informed of the accomplishment of any of said condition by a means such as by a message sent from at least one of, said intermediate device, said main device and the controlling application/server to the account server.

Preferably, the decrypting key is sent to the main device through the Internet (e.g., by using the IP address of the main device). Alternatively, said key is sent to the main device by another messaging system such as SMS (e.g., through another communication system such as a cellular system.

Preferably, the encrypted code is sent to the intermediate device by a messaging system such as SMS. Alternatively, the encrypted code is sent to the intermediate device through the Internet (e.g., by using the IP address of the intermediate device).

Optionally, a/the contact information (e.g., a telephone number) of the main device is provided by the user (e.g., or automatically captured by the account server) preferably during the log in procedure within (e.g., optionally, during the sign-in procedure of) said protected account. Said contact information may be used by the account server 1009 for sending said/a decryption key to the main device 1001 for decrypting said security code (e.g., by the main device 1001) during a log in procedure. In this example, in server 1009, a number of information 1008 provided through a/the corresponding sign-in procedure (e.g., account identification (ID), password, telephone number of the intermediate device 1002 and telephone number of the main device 1001) are stored and preferably at least some of said information may be used during a corresponding log in procedure.

If said security code is encrypted, then, a key for decrypting said security code is (e.g., simultaneously) sent by the account server to the main device 1001 (e.g., by using the contact information (e.g., IP address of the main device 1001 or by using the telephone number of the main device 1001, if provided or captured during log in procedure and/or during sign-in procedure, or otherwise, etc.).

With continuous description of the current embodiment, upon receiving said security code by the main device 1001 (e.g., from/through the intermediate device), if said security code is received in an encrypted manner, then, said main device, may preferably, use said decrypting key for, decrypting said security code.

According to a first aspect, (e.g., after being decrypted) said security code is presented/displayed on the screen of the main device 1001. At this time, a person controlling the main device 1001 may enter, manually (e.g., type/copy-and-paste), said security code within a predefined input field (e.g., text field) of a log in interface of the account server displayed on the screen of the main device. Then, upon providing an interaction by the person controlling the main device (e.g., upon pressing a send button) 1001, the main device may send/transmit 1007 the received security code to the account server 1009.

According to a second aspect, a controlling application (e.g., a controlling application is described in this patent application) running within the main device 1001 may, preferably automatically, transmit 1007 the received security code (e.g., or a security code related to, or calculated based on said security code) to the account server 1009.

(According to a third aspect, upon receiving said security code, by the main device 1001, from the intermediate device 1002, another entity may send said security code to the account server 1009).

After receiving the security code from the main device 1001 by the account server 1009, the main device 1001 is, preferably, given access to the corresponding (e.g., user's) protected account (e.g., in the account server) (e.g., the user is logged in to his/her protected account and a corresponding webpage is preferably opened on the screen of the user's device 1001 for navigation in the user's protected account.).

The procedure of sending a request from the main device to an account server for logging in to a protected account, followed by sending a security code from by the protected account server to an intermediate device, and so on, until the protected account server receives back said security code (e.g., or another security code related to and/or based-on said security code) from the main device may be referred herein as an “authentication procedure/circuit/system”.

As mentioned, the intermediate device 1002 may preferably use a transmitter with/using limited transmitting range (e.g., system). Therefore, as shown in FIG. 1B, if the main device 1001 is outside of (e.g., is far from) the range of said transmitter of the intermediate device 1002, then, communication between the intermediate device 1002 and the main device 1001 may not established 1106 and the main device 1001 may not receive the corresponding/said security code from the intermediate device 1002. In this case, the authentication circuit/procedure is not completed (e.g., is interrupted) and the main device 1001 cannot/will-not have an access to the corresponding user's protected account. According to one method, the intermediate device 1002 may preferably continue/repeat (e.g., the attempt) to send the security code to the main device 1001, preferably, for a predefined laps of time (e.g., after which the security code preferably becomes invalid (e.g., by the account server 1009)). According to another method, after a predefined laps of time, the intermediate device 1002 ceases (e.g., the attempt) to repeatedly send the security code to the main device, etc.).

According to one method, when an account server receives (e.g., back) a/the security code from a/the main device, preferably, said account server checks if said security code had been sent by the account server to an intermediate device during a predefined lapse of time before receiving said security code back from main device. If said security code had been sent to the intermediate device before said predefined laps of time, then, preferably, said the account server considers said security code as invalid.

In continuation description of the current embodiment, according to another method, the laps of time between the moment a security code is sent from the account server 1009 (e.g., to an intermediate device) until the moment the account server 1009 receives back said security code (e.g., or a security code related to/based on the security code sent by the man device) from the main device 1001 may be limited to a predefined amount of time (e.g., less than 5 minutes, less than 1 minute, less than 10 seconds, less than 5 seconds, less than 1 second, less than 500 milliseconds, etc.), after which said security code becomes invalid and an authentication circuit will not be completed/accepted by the account server. In this case, a new request for connection to said protected account may be sent by (the user of) the main device 1001 to the account server 1009, and so on. According to another method, the laps of time between the moment a security code is sent from any of the devices of the authentication circuit to another device of said circuit and received by said another device may be limited to a predefined amount of time (e.g., as described herein), after which said security code becomes invalid. In this case, a new request for connection to said protected account may be sent by the main device 1001 to the account server 1009, and so on.

The method of accessing a protected account described above is secure, easy and has many advantages. According to a first scenario, as mentioned, in order to get access to a desired protected account, the main device 1001 and the intermediate device 1002 must preferably be near/close to each other. As an example, if both devices are at/in a user's home near each other, the user can securely connect to any of his/her desired protected accounts. On the other hand, if the user takes his main device 1001 with him outside his home, then, the user will not be able to connect to a desired protected account because the intermediate device 1002 is remained at user's home far from the main device 1001. As such, if one of the user's devices 1001 or 1002 is, for example, lost or stolen, the person controlling/possessing the lost or stolen device cannot access any of the user's protected accounts through said lost or stolen device. According to a second scenario, as shown in FIG. 1C, for more security, the intermediate device 1002 may have a (e.g., physical and/or virtual) feature/means for manually interrupting (e.g., and/or establishing) the communication 1206 between the intermediate device 1002 and the main device 1001 (e.g., by, for example, turning off/on (e.g., the corresponding transmitter of) the intermediate device. In this case, preferably, said communication may generally be interrupted, and a user may, preferably, manually establish the communication between the intermediate device and the main device when needed/desired (e.g., by turning on the (e.g., the transmitter of) the intermediate device using said feature/means) such as only when the user desires to access a (e.g., remote) protected account. According to a third scenario, a security key received by an intermediate device is transmitted to the main device by a manual/physical authorization action provided by a/the user controlling said intermediate device. As an example, after a security code sent by an account server is received by an intermediate device, a request for authorization may be presented (e.g., by the controlling application) to the user controlling said intermediate device. Preferably said request may be in form of an intractable interface/button displayed on the screen of the intermediate device. Upon interacting with said interface/button said received security code is preferably sent to the main device by the intermediate device.

According to one embodiment of the invention, an intermediate device (e.g., 1002) may (e.g., also have, and) use (e.g., in specific/certain situations/condition, based on a user's command, etc.) a long-range transmitting technology (e.g., Internet, cellular, Wi-Fi, etc.) during an authentication procedure. In specific conditions/cases, said long-range transmitting technology may be used by the intermediate device, for preferably transmitting the/a security code received (e.g., by said intermediate device 1002) from the account server (e.g., 1009) to the main device (e.g., 1001). In this case, even if the intermediate device is far from the main device, the intermediate device may be able to send said security code to the main device successfully. As an example, an authentication circuit with an intermediate device within an authentication circuit (e.g. 1002) using a short-range transmitter may be used for accessing highly-sensitive protected accounts (e.g., bank protected accounts, online stores, etc.), and an authentication circuit with an/said intermediate device (e.g., 1002) using a long-range transmitter may be used for accessing low-sensitive protected accounts (e.g., an online library protected accounts, online media protected accounts, etc.). Any of the devices of an authentication circuit may preferably have, both, a short-range transmitter and a long-range transmitter.

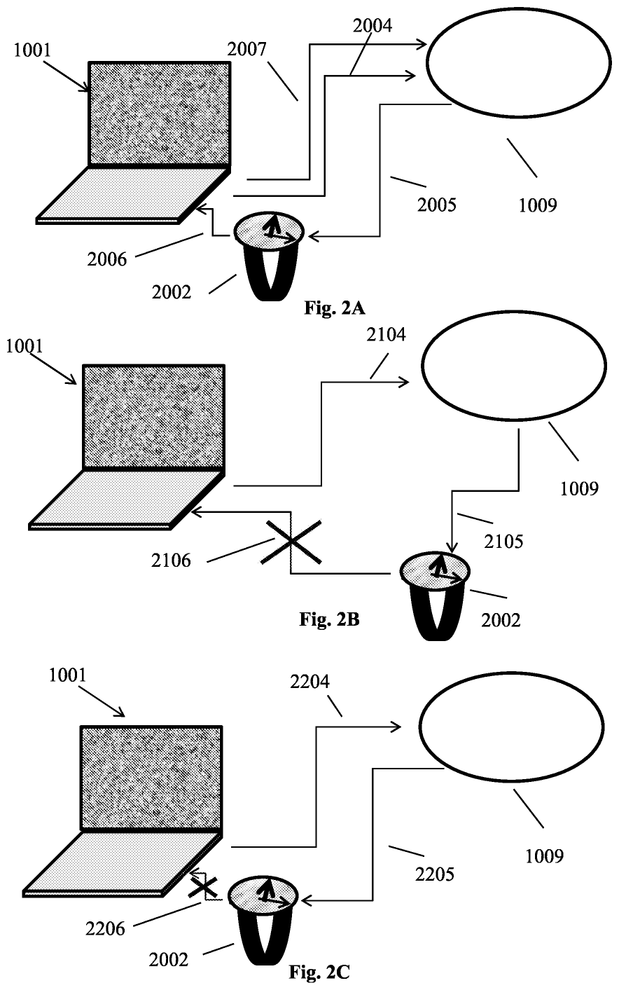

The/an intermediate device may be of any kind. According to one embodiment, as shown in FIG. 2A, the intermediate device may preferably be a wearable device 2002 (e.g., a wrist device such as a smartwatch). A wearable intermediate device may be very advantageous because it is usually worn by a user and most probably cannot be lost or stolen (e.g., together with a/the corresponding main device). Preferably, the wearable (e.g., the intermediate) device 2002 uses a transmission technology for/limited-to a very short distance/range as described above (preferably, less than 50 or 30 centimeters). This is because the distance between the intermediate device (e.g., the smartwatch) 2002 and the main device (e.g., a laptop, a smartphone, etc.) 1001 is usually very short (e.g., less than thirty centimeter) when a user wears the intermediate device and interacts with (e.g., uses (e.g., types on) a keyboard of) the main device. In this case, the authentication circuit/procedure is highly secured (e.g., a person other than user wearing said smartwatch and not carrying the main device cannot access a protected content/account (e.g., of the user)).

In the current embodiment, as shown in FIG. 2B, if the main device 1001 is far from (e.g. is out of the transmission range of) the user's wrist device 2002, for example, because the wrist device is lost or stolen, the authentication circuit cannot be completed because a/the communication 2106 between the wrist device 2002 and the main device 1001 cannot be established, and accordingly, an authentication procedure/circuit will not be completed. As such, a third party who controls the main device 1001 cannot access to any of the user's (remote) protected accounts.

According to one embodiment, as shown in the exemplary FIG. 2C, for more security, the intermediate/wrist device 2002 (e.g. and/or the main device) may have a (physical and/or virtual) feature for manually interrupting and/or establishing the communication between the intermediate/wrist device 2002 and the main device 1001 (e.g., by turning (e.g., the transmitter of) the intermediate/wrist device off or on). In this case, a user may, preferably, manually establish the communication between the intermediate/wrist device (only) only when needed/desired (e.g., by turning on the (e.g., the transmitter of) the intermediate/wrist device) such as when the user desires to access a remote protected account.

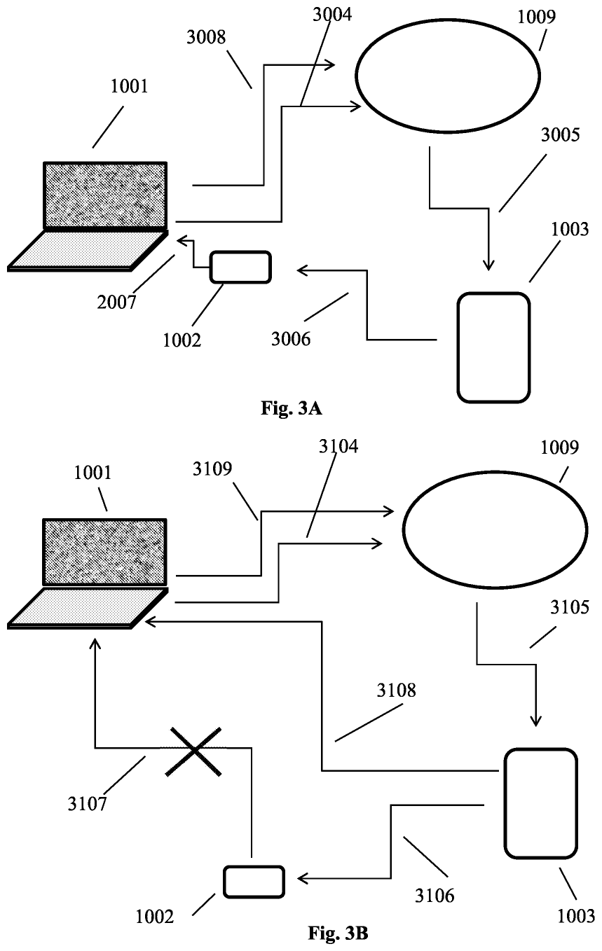

According to one embodiment of the invention, the authentication circuit may have more than one intermediate device (e.g., such device may herein be referred to as, an “additional intermediate device”). As an example, as shown in FIG. 3A, an additional intermediate device 1003 such as a smartphone (e.g., of a third party, such as a family member of the user), may be defined to be an additional intermediate device of the/an authentication system/circuit. In this case, after a request 3004 is sent by a main device 1001 to access a (e.g., remote) protected account within the account server 1009, a security code may be sent 3005 by the account server 1009 to an additional intermediate device 1003, then said security code is sent 3006 by said additional intermediate device 1003 to the intermediate device 1002, and then the security code is sent 2007 from the intermediate device 1002 to the main device 1001, and then, the security code is sent 3008 from the main device 1001 to the account server 1009 for completing the authentication circuit/procedure. It is understood, that in accordance with this embodiment, the contact information of an intermediate device provided during the corresponding sign-in procedure to the account server, is preferably the contact information of the additional intermediate device 1003.

The current embodiment has many advantages. As an example, as shown in FIG. 3B, if, for some reason, a connection between the intermediate device 1002 and the main device 1001 cannot be established 3107 (e.g., because the intermediate device 1002 is far from the main device 1001), then, the user may get in contact through a predefined procedure (e.g. such as a phone call) with the party controlling the additional intermediate device 1003, and upon agreement, said party may provide/send 3108 the received security code directly (e.g., through an SMS/email, etc.) to the main device or provide (e.g., verbally) said security code as is (e.g., in encrypted or non-encrypted form) to the user controlling the main device 1001. Then, the (e.g., user of the) main device may send said security code to the account server 1009 for completing the authentication procedure/circuit.

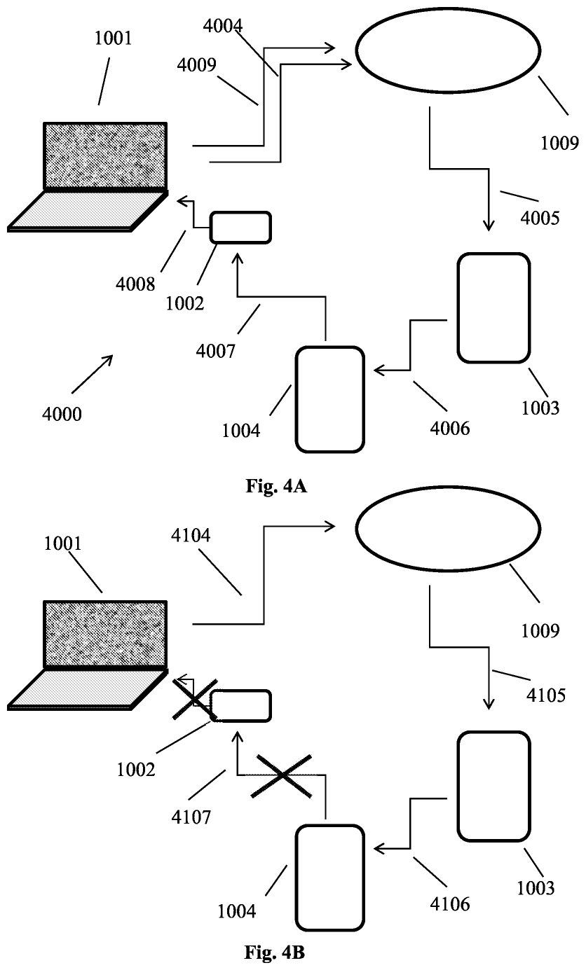

According to one embodiment, as shown in FIG. 4A, an authentication circuit may have more than one additional intermediate device communicating to/with each other (e.g., in a serial manner and/or in a parallel manner) to create an authentication circuit. In the example of FIG. 4A, at first an access request is sent by the man device 1001 to the account server 1009. (e.g., After verifying and validating the authenticity of the identification of the main device 1001, or of the person controlling the device 1001), the account server may send 4005 a security code to a first additional intermediate device 1003 in the authentication circuit 4000. The intermediate device 1003, may then transmit 4006 the security code to a second additional intermediate device 1004. Then the additional intermediate device 1004 may send 4007 said security code to the intermediate device 1002 (e.g., the intermediate device that is in charge of sending the information (e.g. security code) to the main device). The intermediate device 1002 may then send 4008 the security code to the main device 1001. Finally, said security code is sent 4009 by the main device 1001 to the account server 1009, to complete the authentication circuit.

With continuous description of the current embodiment, as shown in FIG. 4B, if any/one of the intermediate devices (e.g., 1004) is not available (e.g., is turned off), the authentication circuit cannot be completed and the user cannot access a/the desired protected account.

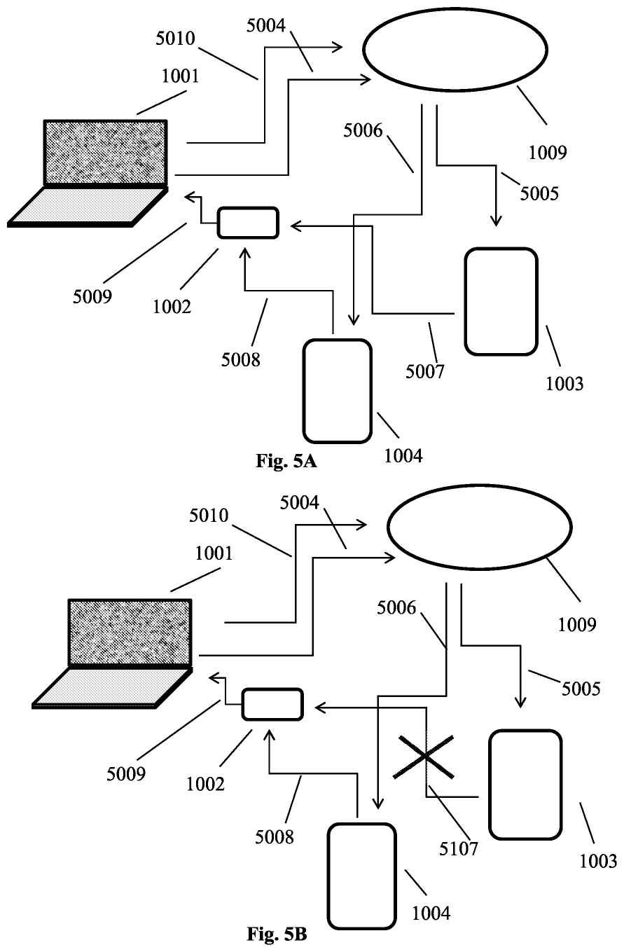

According to one embodiment, as shown in FIG. 5A, an authentication procedure/system may have more than one authentication circuit. Preferably, said authentication circuits work in a parallel manner (e.g., and, preferably, independently from each other). FIG. 5A shows, as an example, an authentication system/circuit having a number of devices similar to the devices of the system/circuit of FIG. 4A. In this example, when a request for accessing an protected account is sent 5004 by a main device 1001 to an account server 1009, the account server 1009 may send (5005 and 5006) a (e.g. a different or the same) security code to each of a plurality of (predefined) additional intermediate devices (e.g. in this example, respectfully, to the additional devices, 1003 and 1004). Then, each of said additional intermediate devices may, preferably independently from each other, send (e.g., 5007 and 5008) the received security code to the intermediate device 1002. Then, the intermediate device 1002 may send 5009 at least one of the received security codes to the main device 1001. Then, the main device 1001, automatically or by the intervention of the user controlling the main device (e.g. by typing the security code (after being decrypted in the main device 1001) received from the/an intermediate device in a predefined text field), may send 5010 the received security code to the account server 1009 for completing the authentication procedure.

The current embodiment is very advantageous. As an example, as shown in FIG. 5B, if for any reason one or more of the plurality of additional intermediate devices (e.g., 1003) is/are not available (e.g., is/are turned off), the authentication procedure may still be accomplished if (e.g., only) one (or more) of the devices (e.g. 1004) of said plurality of additional intermediate devices is/are available. In this example, the additional intermediate device 1003 is, for example, turned off, therefore, the security code is not received by said device 1003 and/or cannot be transmitted 5107 by said device to the intermediate device 1002. On the other hand, the security code received by the additional intermediate device 1004 may be transmitted 5008 to the intermediate device 1002, and from there to the main device 1001. Then, the main device 1001 transmits said security code to the account server 1009 for completing the authentication circuit.

As mentioned before, a user may have created a number of different authentication circuit for a number of different account servers,

According to one embodiment of the invention, an intermediate device receiving a security code from an account sever, is preferably informed about/of the identification (“ID”) of said account server. Preferably, the account server sends its identification information (e.g., together/simultaneously-with the security code) to the intermediate device. Optionally, the intermediate device identifies the account server ID based on other information such as the telephone number by which the/a SMS containing said security is sent to the intermediate device. In this case, the intermediate device may send said identification information to the controlling server so that the controlling server use the corresponding authentication (e.g., parameters of the/a corresponding controlling) account (e.g., when communicating with the intermediate device). This step may be necessary for a controlling server having more than one controlling account.

According to one embodiment, a/the transmission direction of a security code within the/an authentication circuit may be in any predefined different manner. As an example, after sending an access request by a main device to the account server, the account server may send a security code to the intermediate device, and from there to an additional intermediate device, and so on.

Note that, the account server may send more than one security code to an (any) intermediate device. Also, for stronger/enhanced security, any of the devices within an authentication circuit may be able to produce one or more additional security codes (e.g., preferably based on the security code sent by the account server) and send them to another device in the circuit, and so on.

Note that, any of the devices of/within an authentication circuit may (e.g., have and/or) use any communication technology such as Internet, cellular, Wi-Fi, Bluetooth, NFC, etc.

According to one embodiment of the invention, an authentication system/circuit of the invention may include/use an application (e.g. herein may be referred to as “controlling application”) for defining and/or controlling an authentication circuit/procedure. Said controlling application may have/use (e.g., a protected account within) a (e.g., its own) server (e.g., herein may be referred to as a “controlling server), wherein said controlling server is preferably separately/independently from an account server. Said controlling server is controlled preferably by an administrator (e.g., herein may be referred to as an “admin of the/a controlling server”) which, preferably, is the person who controls/owns the main device of the authentication circuit.

Preferably, said controlling application, and/or a derivative (e.g. a specific version) of said application, is at least installed on one or more (e.g., preferably all) of the devices of an authentication circuit (e.g., account server of an authentication circuit may be excluded). Preferably, said application has/uses a protected account containing some information/data (e.g., parameters (e.g., herein may be referred to as a “controlling account”) within a server (e.g., herein may be referred to as “controlling server”), through which the devices of a corresponding authentication circuit are defined and/or their behavior is controlled. Through a controlling account, behavior of devices of an authentication circuit (e.g., during an authentication procedure) may preferably be defined, modified and/or controlled. The controlling account can also be used for controlling a (e.g., said) corresponding controlling application installed on a device. As an example, the admin of the controlling account can access the controlling server to create an (e.g., a new) authentication circuit and its behavior (e.g., relationship between the device of the authentication circuit). Then, the admin of the controlling account (or another person who has an access to the controlling account) may cause modification/s to definition of an already created authentication circuit and/or its behavior.

A/The controlling application of the invention, running within a device of an authentication circuit of the invention, may execute many tasks including but not limited to receiving an information (e.g., such as a security code) from an account server or from another device within the authentication circuit, analyzing and/or processing the received information, decoding/encoding an/the information, connecting to the controlling server, sending/transmitting an/the information (e.g., said security code) to another device within the circuit, etc. Said controlling application may also include an (e.g. on or more) (interactive) interface/s for processing (e.g. viewing, editing, entering, storing, etc.) data. As an example, after receiving a security code (e.g., sent by a first device by the controlling application or a derive/portion of it, preferably installed on said first device) from a first device by a second device, said security code may be viewed (e.g., by the controlling application or a derive/portion of it, preferably installed on said second device) on the screen of the second device. Then, a person controlling said second device, may, manually, enter (e.g. type/copy-and-paste) said security code within an interface (e.g., of the controlling application or of the interface of a corresponding account server) of said second device and send it to a third device (e.g., the main device or to the account server, etc.).

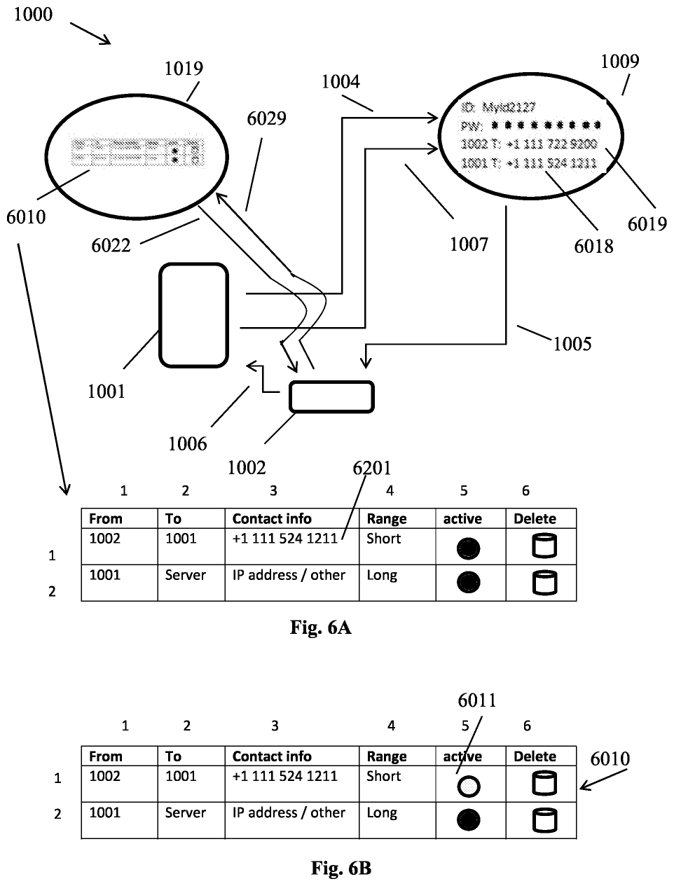

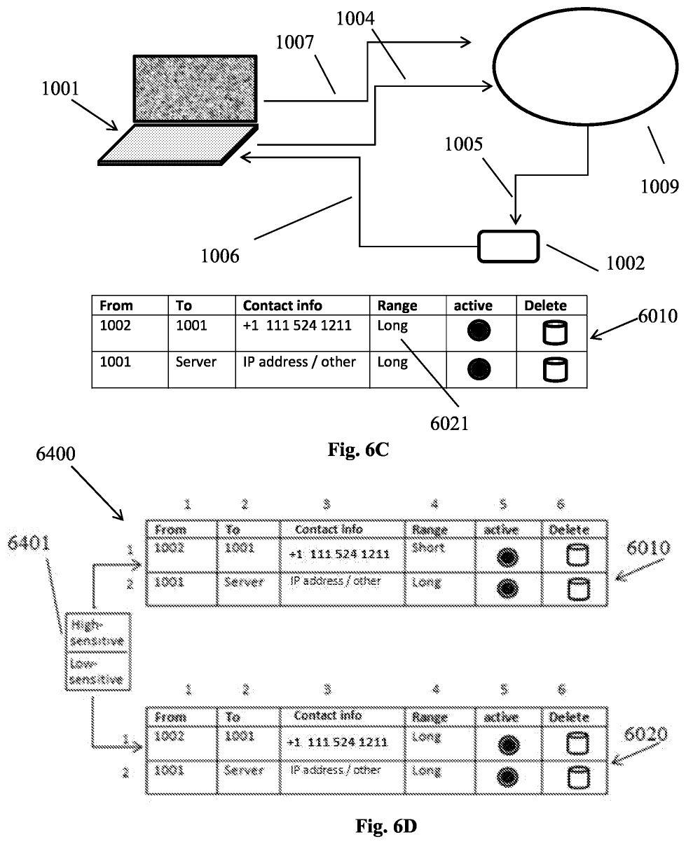

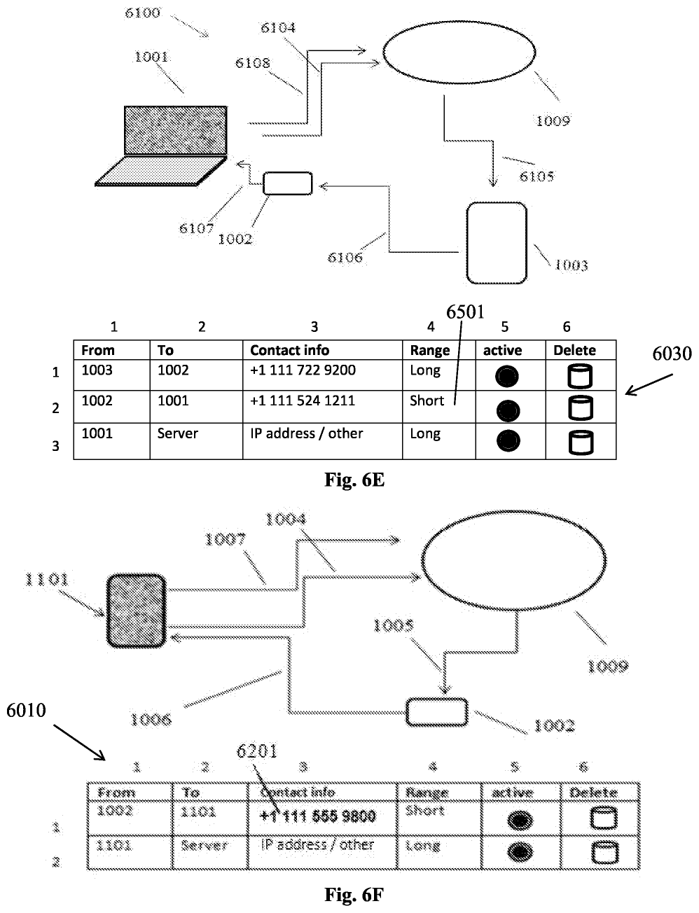

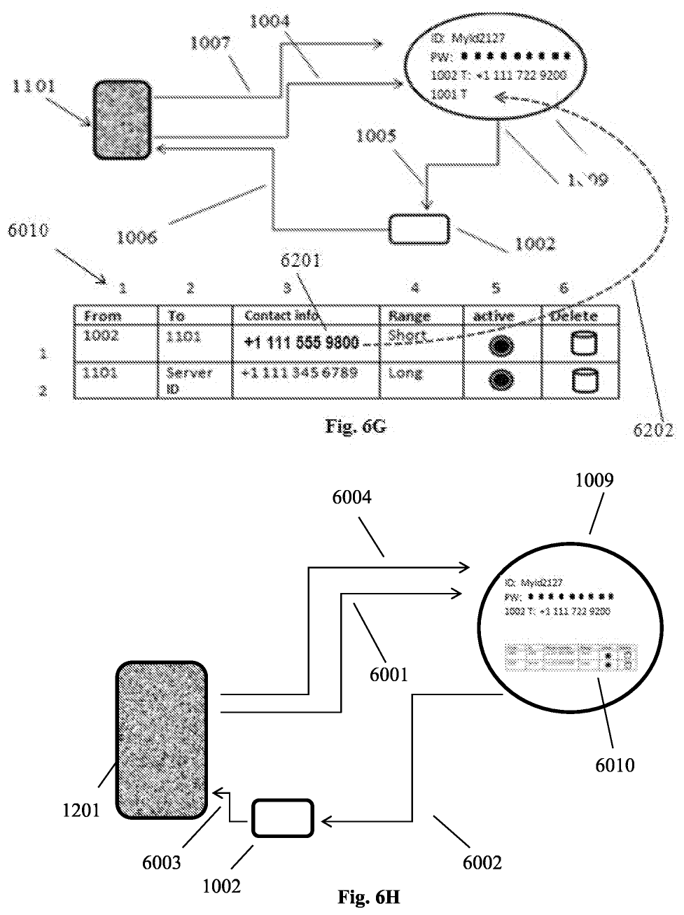

As mentioned, a controlling application/software may have/use a (e.g., corresponding) controlling account within a (e.g., remote/cloud) controlling server (e.g., 1019) to store and/or use some information/data (e.g., one or more controlling parameters, which herein may be demonstrated through an exemplary interface in form of a table of parameters (e.g., 6010). Such table may herein be referred to as a “controlling table”). FIG. 6A, shows an exemplary controlling table 6010 (e.g., within a controlling account) of/used by the/a controlling application of the invention. In this example, said controlling application is installed and running (e.g. in the background) within at least one of, a main device 1001 and an intermediate device 1002. Said controlling application uses the information stored in said controlling table for controlling an/the exemplary authentication circuit (e.g., 1000) similar to that of FIG. 1A.

FIG. 6A, also shows as an example, said controlling server 1019 which is used by (e.g., provides service to) a controlling application of the invention. In this example, the controlling server 1019 holds/has (e.g., at least) one user's controlling account in which a table 6010 (e.g., created/defined/instantiated (e.g., by an admin of said controlling account) for controlling the authentication circuit 1000) related-to/used-by the controlling application is stored.

In this example, said interface is in form of exemplary table 6010 after being filled by an admin of the corresponding controlling sever (e.g., the user controlling the device 1001) with some information corresponding to a/the desired authentication circuit such as that of FIG. 1A. When a user desires to create an authentication circuit, he/she may enter the required information within such a table. In this example, said admin of the corresponding controlling server has entered some information such as information about at least some of the devices of the authentication circuit, relation between each device with another device of said circuit, etc. In this example, each horizontal row of the table 6010, is dedicated to some information regarding a device of an authentication circuit.

It is understood that the table for integrating and using controlling parameters is described here as an example. Other methods for integrating/defining controlling parameters within/used-by a controlling application may be defined/created by people skilled in the art.

According to one aspect, the controlling account may be used for storing and/or executing a software for controlling an authentication procedure. Optionally, said software may be controlled by a controlling application of the invention (e.g., or vise versa).

Preferably, a sign-in procedure and a log in procedure, requiring at least an identification information and a password, is required for, respectively, creating a (e.g., a corresponding controlling table/parameters within said) controlling account and logging in to said controlling account (e.g., for modifying said controlling table). Preferably, said sign-in and log-in procedures are possible through a browser/Internet. For security reason, preferably, said controlling account may be logged in to by/through said controlling application.

In order to use a memory space (e.g., a controlling account) within or and/or related to a controlling server for storing some controlling data (e.g. creating a table of parameters), a user may first create a protected account by executing a sign-in procedure including providing some information (e.g., at least an identification information and a password) to the controlling server. Then, each time said/a user desires to access a controlling account, he//she may preferably have to go through a log in procedure requiring submission of some information such as said identification information and a password by said user. This password is preferably, the only password that a user may keep on mind/remember it or keep it handy because as will be described later herein, in some cases, a user may want to access a controlling account within a controlling server to change one or more parameters.

With continuous description of the current embodiment, as an example, in table of parameters 6010 each horizontal row defines a different device and the behavior of said device within/of the exemplary authentication circuit 1000 of the invention. As an example, by considering the horizontal row 1, of the exemplary table 6010:
in column 1, the reference/identification number of the intermediate device (e.g., in this example, 1002) which is adapted/defined to receive a security code from an account server is entered.
in column 2, the reference/identification number of the following device in the authentication circuit (e.g., in this example, 1001, the main device) to which said security code will be redirected by the intermediate device (e.g., in this example, 1002), is entered.
in column 3, the telephone number of the following device (e.g., in this example, 1001) to which said security code will be redirected is entered.
in column 4, an admin of the controlling server/account can define which one of the transmitters (e.g., short-range or long-range) of the device 1002 should be used for transmitting a received security code to the following active device (e.g., in this example, 1001).
in column 5, an admin of the controlling server/account can activate or deactivate the current intermediate device (e.g., in this example, 1002) in the authentication circuit.
in column 6, an admin of the controlling server/account can delete/remove the current intermediate device (e.g., in this example, 1002) from the (e.g., current) authentication circuit.

The above-mentioned explanation regarding columns 1, to 6, can be applied to any of the rows of a/the table (e.g., each row corresponding to different device of the/an authentication circuit). Note that, a (e.g. an intermediate, main, etc.) device can be deleted or added to an authentication circuit. If a device is (e.g., desired to) be added to authentication circuit, a corresponding new row is preferably added (e.g. by a corresponding admin/user) in a corresponding controlling table (e.g. 6010).

According to one example, when an admin/user of a controlling account executes a signs-in procedure within an account server for creating said/a account, he/she may preferably enter a/the contact information 6019 of the device represented by the first row of a corresponding table (in this example, the telephone number of the intermediate device 1002). As such, every time afterwards, that a user of the main device 1001 attempts to log in to said protected account in said account server, the account server sends a corresponding security code (e.g., preferably, via SMS) to said device (e.g., 1002) by using said contact information (e.g., the telephone number). If said security code is encrypted, then, as mentioned before, a key for decrypting said security code is simultaneously sent by the account server to the main device 1001 (e.g., by using the contact information (e.g., IP address of the main device 1001 or by using the telephone number 6018 of the main device 1001, if provided during sign-in procedure, etc.).

Preferably, the controlling parameters are controlled/managed by a user authorized to access a controlling account (e.g., an admin). As an example, said user may make modifications to the parameters (e.g., within a/the table) stored within said controlling account to make changes to the behavior of a (e.g., one or more devices) of a corresponding authentication circuit. As an example, an admin of a controlling account may preferably have the ability, to pause, disable or remove any of the intermediate devices in or from the authentication circuit, by making corresponding changes within the parameters (e.g., within the controlling table).

Optionally, the behavior of a (e.g., one or more devices) of an authentication circuit may be controlled by another device (e.g., of the authentication circuit). According to one aspect, a user controlling the main device 1001 may request a user of another device within an authentication circuit to disable his/her device within the authentication circuit (e.g., to pause or disable his/her device of doing an (e.g. any) action within the authentication circuit). According to another aspect, the user controlling a main device may preferably have the ability (e.g., through an application controlling the corresponding authentication circuit) to pause, disable or remove any of the intermediate devices in or from the authentication circuit.

As mentioned, the intermediate device (e.g., in this example, 1002) represented by/in the first row of the table 6010, is preferably, the device to which an account server within an authentication circuit sends 1005a/the security code as described herein, preferably through an SMS application. After receiving the security code by the intermediate device (e.g., in this example, 1002), said security code is sent 1006 to the following active device represented by a following horizontal row of the table. In this example, said device is 1001.

In this example, the security code received (e.g., by the SMS application of the device 1002) from the account server (e.g., 1009), is preferably captured/intercepted by the/a controlling application of the invention running within the device 1002 (e.g., from the SMS application of the device 1002). Then, according to one aspect of the invention, said controlling application executes a process for sending said security code (e.g., automatically) (e.g., through the SMS application of said device 1002), to the next active device 1001 represented by a following horizontal row of the table.

A controlling account may have/hold more than one controlling tables, each corresponding to a different authentication circuit/procedure. As an example, in a single controlling account, a user may create a first controlling circuit for accessing a high-sensitive protected account, and create a second circuit for accessing a low-sensitive protected account.

According to one aspect, when a user/admin attempts to log in to the controlling server and/or attempts to change/modify a parameter within a controlling account, the controlling server and/or the controlling account may preferably send a notification (e.g., an alert) message to at least one, preferably all/both (e.g., the main and the intermediate) of the devices of a corresponding authentication circuit. Preferably, (e.g., the user of) each of the devices is required/requested to respond to said notification message by, for example, sending a predefined message to the controlling server so that to authorize said log in to the controlling server and/or said modification.

It is important to note that examples of telecommunication (e.g., herein may be referred to as “communication) technologies (e.g., SMS for long-range, NFC, for short-range), for transmitting of a security code from one device to another device in an authentication circuit, are used as an example to describe the principles of the authentication procedures of the invention. It is understood that any selected/predefined communication technology (e.g., Internet, cellular, Wi-Fi, etc., for the long-range, Bluetooth, NFC, etc., for the short-range), may be used for the same purpose.

Note that according to one method, a/the controlling application running within a device (e.g., intermediate device 1002) may preferably be in charge of receiving/capturing a/said security code (e.g., sent from an account server 1009 to said intermediate device 1002, and, thereafter, communicating and/or interacting with a corresponding controlling server 1019, sending/redirecting said code (e.g., through a selected/authorized communication technology (e.g., NFC)) to another device (e.g., 1001), etc.

A controlling server may include a plurality/many controlling accounts each managed/owned by an (e.g. a different and/or a same) admin of a corresponding controlling account.

A controlling server may include a plurality of controlling accounts wherein each of at least some of said controlling accounts corresponding to a different controlling circuit and/or a different controlling application.

Access to a different controlling account is/may-be permitted by providing a (e.g. different) corresponding log in information (e.g., provided earlier/previously by an admin of said controlling account during a corresponding sign-in procedure).

According to one embodiment, a first controlling table may be used by a corresponding authentication circuit/procedure for logging in to a first protected account within a first account server, and a second controlling table may be used by a corresponding authentication circuit/procedure for logging in to a second protected account within said first account server or within a second account server. As an example, a first controlling table may be used for logging in to a bank protected account within a corresponding account server, and a second controlling table may be used by a corresponding authentication circuit/procedure for logging in to a media store. Preferably, each of the controlling tables may be related to a corresponding protected account within a same or a different account server.

Note that, the controlling application using a controlling account having an interface (e.g. in form of a table) including some (e.g. one or more) parameters, are described and shown as an example, for describing the gist/principles of the invention. Any other type of application using a controlling account having any type of (e.g. interface of) parameters for controlling the execution of an authentication procedure may be defined by people skilled in the art.

With continuous description of the current embodiment, the exemplary FIG. 6B shows that at some point/moment, the admin of the controlling account has accessed the controlling account and the corresponding table 6010, and has disabled/unauthorized (e.g. by switching the corresponding button 6011 from “On/active” status to “Off/non-active” status) the device 1002 from sending information (e.g., a security code) received from an account server (e.g., 1009) to the/a next (e.g. main) device 1001. As an example, if the owner of the main device, notices that the main device 1001 and/or the intermediate device 1002, is/are being lost and/or stolen, said user may disable/unauthorize the intermediate device 1002 to send a security code received from the account server 1009, to the lost and/or stolen main device 1001. In this case, the authentication procedure cannot be completed, therefore, a person possessing the lost/stolen main device 1001 cannot access (any of) the user's protected accounts.

As mentioned before, an intermediate device may have, both, short-range transmitter and long-range transmitter. According to one embodiment of the invention, an admin of an admin of a controlling account within a controlling server may define and/or modify a (e.g., one or more) definition/parameter of transmission of information (e.g., a security code) from a first (e.g., an intermediate) device to a second (e.g., a main) device (e.g., within a corresponding table) in the controlling account. As an example, by considering the authentication circuit of FIG. 6A, in some situations/conditions, the intermediate device 1002 may be far from the main device 1001. Accordingly, successfully transmission of a received security code by the intermediate device 1002 to the main device 1001 (e.g., automatically) becomes interrupted/impossible because of the distance between said devices (e.g., said distance being longer than the transmission range of the short-range transmitter of the intermediate device). As such, as shown in FIG. 6C, an admin of the/a corresponding controlling account may access to said controlling account within a corresponding server and modify the corresponding parameter within the controlling table 6010 by changing the corresponding transmitter parameter 6021 from short-range to long-range. Accordingly, the intermediate device 1002 may preferably become permitted to transmit/redirect 1006 a security code (e.g., received from the account server 1009), to the main device 1001 through a long-range transmitter of said intermediate device 1002. In this case, the user of the main device may access a (e.g., his/her) desired protected account even if the intermediate device 1002 is far from the main device 1001.

With continuous description of the current embodiment, preferably, if said protected account is a high-sensitive protected account. As such, preferably, before switching the transmission parameter 6021 of the intermediate device 1002 to ‘long-range” for accessing a protected account, said user may preferably make sure that the intermediate device is safe to use (e.g., is not stolen, lost, etc.).

With continuous description of the current embodiment, according to a preferred aspect, upon accomplishment of a condition (e.g., such as at least one of, when the corresponding log in authentication circuit/procedure is accomplished, after a predefined (short) amount of time, immediately after the intermediate device 1002 redirects/sends a (e.g., received) security code to the following device 1001, immediately after the controlling application running within the intermediate device is given a permission by the controlling account, to send said information (e.g., the said security code), using a long-range transmitter, to another device, etc.), the corresponding parameter 6021 is preferably automatically switched back (e.g., by the controlling server or by a corresponding controlling application, etc.) to “short-range”.

An admin of a controlling account may define (e.g., create) at least two types of controlling table for an (e.g. a single) authentication circuit. In the exemplary FIG. 6D, an interface 6400 of a controlling account having two types of controlling tables is shown. A first controlling table 6010 in which a transmission range parameter of a (e.g., an/the intermediate) device is set to “short-range” (e.g., herein may be referred to as a “high-sensitive table”) may be defined/used for accessing a high-sensitive protected account, and a second controlling table 6020 in which a transmission range parameter of a (e.g., an/the intermediate) device is set to “long-range” (e.g., herein may be referred to as a “low-sensitive table”) may be defined for accessing a low-sensitive protected account.

According to one embodiment, said admin of the corresponding controlling account (or any other authorized physical or virtual (e.g. a software) entity having an access control to said controlling account) may select a desired table among said tables before attempting to log in to a protected account. A switching feature 6401 adapted to activate a first table among said tables may be used by said admin (or vise versa). As such, the second table may become deactivated (or vise versa). When a user attempts to access/log in to a desired protected account, the selected/activated controlling table is (e.g., automatically) used by the corresponding controlling application during an authentication circuit/procedure.

According to a preferred embodiment, as shown in FIG. 6A, preferably, the controlling account has one controlling table (e.g., 6010) in which, preferably by default, the transmission range parameter of the intermediate device (e.g. 1002) is in (e.g., set to) “short-range” status, therefore, the log in procedure to a (e.g., any) protected account is preferably controlled based-on/by a/the high-sensitive table 6010, unless otherwise (e.g. low-sensitive controlling table/procedure) is desired for the logging-in-to/accessing a desired protected account (e.g. at a specific moment). In this case, as shown in FIG. 6C, before attempting to log in to said protected account, the user may access the controlling account within the/a corresponding controlling server and change the transmission range parameter of the intermediate device (e.g. 1002) within said table (e.g., 6010) to “long-range” status.

With continuous description of the current embodiment, for security purpose, according to one aspect, preferably, said controlling table may preferably (e.g., automatically) immediately switch back to high-sensitive status after a corresponding low-sensitive (e.g. above-mentioned/latter) cycle of the authentication circuit is accomplished/completed. Alternatively or in addition to said aspect, said table may preferably automatically switch back to high-sensitive status, a predefined lapse of time after being switched to low-sensitive status.

It is understood, that other systems and/or methods of, creating, selecting, controlling, etc., a high-sensitive or low-sensitive authentication circuit and/or authentication procedure may be considered by people skilled in the art in accordance with the principles of authentication procedures of the current invention. As an example, the/a controlling account may have both, a high-sensitive and a low-sensitive controlling tables as shown in FIG. 6D. Preferably, by default, the high-sensitive table is active/selected (i.e., the corresponding authentication circuit is controlled by the high-sensitive table), unless an admin of the controlling server (e.g. the user of the main device) deactivates the high-sensitive controlling table and activates the low-sensitive controlling table. And vise versa.

According to one embodiment, a controlling application may be executed within a controlling server. According to one aspect, the controlling server may be a remote device. According to another aspect, the controlling server may be the main device of an authentication circuit.

A controlling application and/or the authentication circuit may preferably include/use a (e.g., its own) messaging software in which a message (e.g., a security code) sent by a first device (e.g., through a version of a corresponding messaging software running (e.g., in the background and/or in the foreground) within said first device) to a second device within the corresponding authentication circuit, is intercepted by (e.g., a version of the corresponding messaging software running (e.g., in the background and/or in the foreground) within) said second device. And. So on. According to one embodiment, said messaging application may be part-of/included-within and/or work-with the controlling application of the invention. Optionally, said messaging application may work independently from the controlling application but preferably interacts with (e.g., receives and/or sends information/content, respectively, from and/or to) a/the controlling application of the invention.

A controlling application may have different versions wherein each different version is adapted to run (e.g., preferably in the background) within a specific/different/dedicated device within/of an authentication circuit. Alternatively, a same version may be adapted to run (e.g., preferably in the background) within any of the devices of an authentication circuit. A controlling application may be installed and run within at least one or more (e.g. preferably, all) of the devices of an authentication circuit (e.g., said devices communicating with each other, preferably though said controlling application/s running within said at least one or more or all of said device/s), together, forming a communication network.

A controlling application running within a main device may execute some task/s different than some tasks executed by a controlling application running within an intermediate device. As an example, a controlling application running within an intermediate device, may have some tasks such as intercepting a (e.g. an encrypted) security code sent by another device to said intermediate device, (e.g., and if required, re-encrypting said security code), sending a permission request to the controlling server, and, if permitted, redirecting the security code to the following device (e.g., a main device), etc. Also an example, a controlling application running within a main device, may have some tasks such as intercepting a (e.g. an encrypted) security code sent by another (e.g., an intermediate) device to said main device, sending a permission request for decrypting said security code to the controlling server, (e.g., if permitted, decrypting said security code), etc.

As mentioned, an authentication system/circuit preferably has/uses a controlling server/account for controlling the behavior of devices of an (e.g., a corresponding) authentication circuit. As an example, by considering authentication circuit 1000 and the controlling table 6010 of FIG. 6A, after a security code, sent 1004 by the account server 1009 (e.g., the account server to which the user wants to log in to his/her protected account), is received by the intermediate device 1002 (e.g., by SMS system or another communication technology) and intercepted by a (e.g., version of a) controlling application of the invention running within the intermediate device 1002, the intermediate device 1002 may send/redirect 1006 said security code (e.g., or another security code based on said security code) by using a short-range transmitting technology (e.g., short-range transmitter) to the main device 1001, through the (e.g. messaging application of the invention. Alternatively, all of the authentication circuit devices, including the corresponding account server, use a same controlling/messaging application for sending a message (e.g. a security code) from one device to another device. Preferably, said messaging application is a proprietary application of the authentication circuit of the invention and is controlled by the authentication circuit of the invention.

As mentioned, each device of the authentication circuit may preferably have an identification information (e.g., ID) (e.g. an identification number (e.g. 1002), a contact information (e.g., a unique address (e.g., a telephone number, etc.) based on which sending and/or receiving an information from one device to another device becomes effective/possible.

According to one embodiment of the invention, by considering the exemplary FIG. 6A, when an intermediate device (e.g., 1002) receives a message (e.g., security code) from an account server (1009), a controlling application running within said intermediate device may intercept said security code and notify 6029 the controlling server 1019 containing a controlling account used by the controlling application. Based on the status of a/the corresponding controlling table 6010, the controlling server 1019 may preferably transmit send 6022 some (e.g., one or more) parameters/information (e.g., hereafter may be referred to as a “permission”) to the intermediate device based on which the intermediate device executes some process/es. Said parameters may preferably at least include on of:
1) If the intermediate device is permitted (e.g., “Active”) (e.g., or not permitted) to send said security code to a following device;
2) Which type of transmitter to use (Short-range of Long-range);
3) The contact information/address of the following device;
4) Etc.

After getting a permission from the controlling server 1019, the intermediate device 1002 may preferably send 1006 said security code (e.g., or another security code based on said security code) to the main device 1001. After receiving the security code from the intermediate device 1002 (e.g., and decrypting it), the main device 1001 may send 1007 the security code to the account server 1009. The account server 1009 may preferably verify the received code and upon validation of said security code, the account server 1009 gives (e.g., permission to the main device 1001 to) access into a corresponding protected account (e.g., The log in circuit/procedure is successfully completed). According to one embodiment, a permission from the controlling server (e.g., 1009) is required for the controlling application running within the main device (e.g., 1001) for decrypting said/a security code (e.g., a parameter within a corresponding controlling account (e.g., table) may be created (e.g., and, if needed, can be updated/modified) in this regard, by an admin of a/the controlling server). As such, after the main device receives an encrypted security code from an intermediate device, the main device may preferably send a permission request to the controlling server in this regard. Then, upon receiving a permission from the controlling server, said controlling application running within the main device (e.g. or another software) may decrypt said security code.

According to a preferred aspect, the decryption software installed on the main device is provided by and/or is a proprietary of a corresponding account server and/or is controlled by the account server. Preferably, said decryption software is (e.g., downloaded and) installed within the main device by an account server's installation software or from application store such as Apple Store, Google's Play Store, etc. Optionally, the decryption software is provided by and/or is a proprietary of an entity other than said corresponding account server. Preferably, the decryption software is provided by and/or is part of a the/a controlling application of the invention (e.g., installed/executed on a main device) using a/the received decryption key for decrypting the/an encrypted code (e.g., received from the/an account server by an/the main device).

According to one aspect, an encrypted security code received by an intermediate device (e.g. 1002), may preferably be encrypted again, by the controlling application running within said device by using a second (e.g., predefined) encryption key/code, to provide another (e.g. a new) encrypted security code with stronger encryption. This procedure may be repeated by one or more additional (e.g., if any) intermediate devices, each preferably using a different (e.g., predefined) encryption key/code. In addition to the decrypting key received from the account server, one or more decryption key/s used for decrypting for the latter encrypted security code/s may (e.g., predefinely) be available within the main device and may be used by a decryption software (e.g., of/used-by the controlling application) running within a/the main device (e.g., 1001) for decrypting said latter encrypted security code/s. When a main device receives said encrypted security code from an intermediate device, said main device may use the decrypting key received from the protected account server and a e.g., one or more) decrypting key/s corresponding to decryption made by a (one or more) intermediate device/s to decrypt the said security code.

After the accomplishment of the decryption procedure, the decrypted security code is sent/transmitted to the account server. According to a preferred aspect, the decrypted security code is displayed on the screen of the main device, and the user is required to manually enter/type said security code in a dedicated (e.g., text) field displayed on the screen of the main device and (e.g., and press on a Send key to) send it to the account server. Alternatively (e.g., after decryption), said security code is automatically sent to the account server by the main device.

According to another embodiment, a controlling application running within a (e.g., an intermediate) device may have its own controlling parameters/table located locally within said device. Said controlling parameters/table may preferably be updated by the controlling server (e.g., each time a corresponding table within a controlling server is modified/updated). As such the controlling application may execute a function (e.g., to send or not sent a received message/security code to another device) based on said/its own parameters/table located/stored in the intermediate device. As such, every time a controlling table is created and/or modified, each of the relevant controlling applications installed within an intermediate device may automatically (e.g., locally) be updated. In this case, getting permission from the controlling server is not needed by an intermediate device when receiving a security code. Same principles may be applied to the main device as well.

As mentioned before, an authentication circuit may have one or more additional intermediate devices. FIG. 6E, shows an authentication circuit with two intermediate devices 1003 and 1002. Accordingly, a corresponding controlling table 6030 in high-sensitive status (e.g., the authorized transmission range 6501 within the authentication circuit by the intermediate device 1002 is set to “Short”) is created within a corresponding controlling server. In order to switch said table to a low-sensitive status, the admin of an account within the controlling server may change the range of device from “short” 6501 to “long”.

### Sign-In (e.g., Registration) Procedure for Creating an Access Control to a Protected an Account

Sign-in procedure for creating an account in an account server is known by people skilled in the art and/or by the general public. As an example, a user may be required to (e.g., create and) provide some information such as a user's identification information (e.g., a username), a password and a contact information (e.g., a telephone number, an email address, etc.) for sending a security code to that telephone by the account server each time a user attempts to access said/his/her account ((e.g. herein may be referred to as a log-in procedure).

According to one embodiment of the invention, for creating an account within an account server, a user (e.g., an admin) may first successfully accomplish a sign-in procedure in said account server. The sign-in procedure may preferably be similar to the sign-in procedure described above with the difference that in the sign-in procedure of the invention, a user may provide at least the contact information of an/the intermediate device and the contact information of a/the main device. As an example, the user may first open a sign-in webpage of a desired website/account server in a browser. The corresponding account server may require a list of user's information such as:
1. A username (An account identification information such as a user's arbitrary/desired text such as his/her email, telephone number, an ID, etc.)
2. A password;
3. A contact information (e.g. a telephone number) of an intermediate device for sending a (e.g., an encrypted) security code by the account server during a log in procedure;
4. A contact information (e.g. a telephone number) of a main device for enabling the account server to send, a key for decrypting said encrypted security code, to the main device;
5. Etc.

The user, then, sends (e.g., by pressing a corresponding send button) said information to the account server (e.g., via a communication system such as Internet, Wi-Fi, cellular, etc.). The account server stores said information within (e.g., an entry of a database of) said account server.

The sign-in procedure is accomplished.

### Log In Procedure for Accessing an Already Registered Protected Account

Below are exemplary steps for logging in to an already registered/signed-in to protected account (e.g., said protected account) within an/said account server:
1. A user controlling said/a main device, may first open a log in webpage/interface of a corresponding website/account server on a/his/her device (e.g., the main device);
2. The user enters said the corresponding protected account identification information (e.g., the username) (e.g., said user's arbitrary/desired text, which was provided during the sign-in procedure, and sends (e.g., by pressing a corresponding button) said information to the account server (e.g., via a communication protocol/technology such an Internet, Wi-Fi, cellular, etc.)
3. The account server compares the received identification information with the corresponding identification information stored within (e.g., the entries of said database of) said account server. After successfully matching said identification information with an/the identification information (e.g., stored (e.g., within an entry of said database), the account server sends (e.g., by SMS) a (e.g. an encrypted) security code to the intermediate device according to a corresponding contact information (e.g. the telephone number) of said intermediate device stored in the (e.g., protected account of the) account server. If the security code is encrypted, the protected account sever may, preferably simultaneously, send (e.g., by SMS, by email, etc.) a key for decrypting said encrypted security code to the user's main device according to the contact information (e.g. the telephone number, email, etc.) of said main device stored in said account server.
4. after receiving said (e.g., encrypted) security code, by said intermediate device, from the account server, if said intermediate device is active (e.g., authorized by the controlling application), the intermediate device sends/redirects said (e.g., encrypted) security code (e.g., by for example, a Near Field Communication (NFC) system (e.g., if the device is defined to use a short-range communication system/transmitter), or otherwise, (e.g., if the device is defined to use a long-range communication system/transmitter) by a long-range communication system to the following device as defined in the corresponding controlling table of the corresponding controlling sever. According to a preferred scenario, said following device is the main device. According to another scenario, said following device is another intermediate device. In this case, Step 4 is repeated until the following device is a main device.
5. According to one aspect, after receiving said (e.g., encrypted) security code, by the main device, said (encrypted) security code (e.g., is decrypted by using said decryption key through a decrypting software (e.g. of the controlling application, of the account server, etc.), preferably, locally within the main device, and):
Option (a) is automatically sent to the account server.
Option (b) is, manually, entered (e.g., by type action/by copy-and-paste action) within a predefined input field (e.g., text field) of a log in interface of the account server displayed on the screen of the main device (e.g. within a browser)

At this time (e.g., after matching, by the account server, the security code received from the main device to the security code sent by said account server to the intermediate device), the authentication procedure is completed and the user of the main device is preferably given access (e.g., by the account server), to the desired protected account.

The steps described above are provided as an example. Other methods of logging in to a protected account may be considered by people skilled in the art, without deriving from the principles of the current invention/application.

If for some reason a user desires to use another device as a main device (e.g., a user changes his/her main device to a new device, uses temporarily another (main) device, etc.) for accessing a protected account, the admin of the controlling account (e.g. said user) may:
a) Replace the contact information (e.g., the telephone number) of the main device in the corresponding controlling account. As an example, in the exemplary authentication circuit of FIG. 1A, if the laptop 1001 is to be replaced by another main device (e.g., a smartphone), then as shown in FIG. 6F, the admin of the corresponding controlling account may modify the corresponding information in the corresponding field 6201 of the controlling table 6010. In this example, the contact information (e.g., the telephone number) of the laptop 1001 is replaced by the contact information (e.g., the telephone number) of the smartphone 1101 in the corresponding field 6201 of the intermediate device 1002 by an admin of the controlling account.
b) Optionally, as shown in exemplary FIG. 6G, the/corresponding contact information (e.g., the telephone number) of the main device in the corresponding (e.g., account in the) account server is automatically updated (e.g., by the controlling server sending 6202 said contact information to the account server Alternatively. the user (e.g., the owner of the account) may log in the corresponding account in the account server and modify said/the contact information of the main device.

It must be noted that, a main device (e.g., a laptop, a smartphone, etc.) and/or an account server in an authentication circuit, may not have/use a telephone number. Although in this patent application, in an exemplary controlling table, a telephone number is indicated/shown as a contact information for transmitting a security code from one device (e.g., or from an account server) to another device, it is understood that said type of contact information is indicated/shown as an example for describing the gist of the invention. Other methods of communication may be used for transmitting a security code from one device (e.g., or from an account server) to another device. For such purpose, variety of communication means/technologies are available and known in the communication industry and/or known by people skilled in the art.

Note that the controlling server may preferably be a remote/cloud server. Optionally, the controlling server may be a device of the authentication circuit, preferably, the main device.

Note that the controlling application of the invention may be a (e.g., complex) software having many parts related to and/or communicating with each other. Preferably, the main part of the controlling application may preferably run within the main device and/or within the controlling server. A derivative of said application may be installed and run within an (e.g., one or more) intermediate device.

According to one embodiment, as shown in the exemplary FIG. 6H, instead of using a controlling server, the controlling application may use a memory space within/related-to a (e.g., each) user's protected account within a/the corresponding account server (e.g., in this example, 1009). As such, a memory space within said account server may be dedicated to the information (e.g., parameters, a/the table 6010) of the controlling application of the invention.

According to one embodiment, the decryption procedure is executed by the account server 1009. In this case, according o one method, a security received by the main device from an intermediate device, is sent, as is, by the main device to the account server 1009. According to another method, a decryption software controlled by an/the account server and installed on a/the main device, may execute the decryption procedure using the decryption key received from an/the account server.

Note that the communication (e.g., transmission of information) between, at least, a main device and a server (e.g., and/or vise-versa), such as a log in attempt within/to a protected account within an account server may preferably be through Internet (e.g., by using an IP address of the main device and the account server).

According to one embodiment, the/an account server is part of a/the communication network of the invention. In this case, according to one method, the account server may have an API that can be used by the controlling application so that an/some information (e.g. a security code) sent by the account server to a (e.g., an intermediate) device of the authentication circuit using said controlling application, may be capture/receive by a controlling application running within said intermediate device. Said API, may also be adapted to capture/receive an information sent (e.g., by using said controlling application) from a (e.g., main) device of the authentication circuit to the account server and vise versa.

Alternatively the account server may use an API of the authentication circuit for the purpose.

According to one aspect, instead of each time entering an/the URL of an account server for logging in to his/her corresponding account, a user may use a an application (e.g., by downloading the application from a website such as an app/play store, etc.) that permits to connect the user's device to a corresponding server upon-activating/through said application. The use of an application for simplifying the procedure of signing in to and/or logging in to an account within an account server is known in the industry and by people using mobile or fixed devices.

An application used for connecting and/or using a user's device to a payment terminal for the purpose of a payment for goods purchased by a user may herein be referred to as “payment application”. An example of such application is Apple Pay, Google Pay, etc.

Authentication procedure(s)/system(s) described in this patent application can (e.g., is/are designed to) be used for executing (e.g., by a user) a (e.g., any) software and/or a (e.g., any) (e.g., physical and/or a virtual) function without using a password wherein executing said software and/or said function (e.g., by said user) requires an authentication procedure (e.g., of a/the/said user) for executing said software/function. As an example, the/an authentication system of the invention may be used for executing functions such as opening a door without using a password, making a payment without using a password, transferring money without using a password, unlocking (e.g., logging in to) a user's protected account in a (e.g., remote) server without using a password, accessing an account in a (e.g., a personal computer (e.g., in this case, the personal computer may preferably functions as an/the account server)), etc.

Online payment companies are in charge of handling online or internet-based systems/methods/services/processes of payment/money transactions. Online payment systems and/or services may be defined in different categories, such as:
Category a) online payment systems which allow the/a seller (e.g., a merchant) to accept payments and the/a buyer (e.g., a cardholder) to make payments over the internet. Examples of online payment companies include PayPal, Google Pay.
Category b) payment services/services of companies handling payment through credit card/debit card such as Visa, MasterCard, Diners, etc., may also be available when purchasing goods on the Internet and/or in a physical store. In the latter, Category c) There may be other companies providing services for transacting payments from one entity to another entity.

A credit card transaction process is complex and has a number of participants in a credit card transaction. Each transaction passes through multiple phases involving several different parties before the seller gets the funds. As an example, a payment terminal and/or a software of the store or eCommerce/online shop with whom a cardholder has initiate a purchase, sends the credit card information of the cardholder to the merchant's bank (e.g., herein may be referred to as “acquiring bank”. Acquiring bank, then, sends a request for payment authorization to the bank issuing the credit card. A request for payment authorization of a credit card transaction goes through a number of participants and networks (e.g., herein may be referred to as “channels”) until it is received by the bank issuing the credit card. An approval or decline response from the bank, said response is sent back along the same channels to the acquiring bank.

When a buyer/user proceeds to a procedure for providing a payment for a goods, a service, transfer of funds, etc., through any of above mentioned (e.g., or other) payment categories, at some instance during the corresponding transaction process said buyer/user may be required to go through an authentication procedure for preventing fraud. Said authentication procedure may require some information to be provided by the user. Said information may be providing a password, a security code sent to the user's smartphone during the authentication procedure, a username, etc. Generally, said information is required by a/the company/institution (e.g., the user's bank, PayPal, etc.) paying the amount of the transaction on behalf/for the user/buyer. For facilitating the simplifying the specifications of this patent application said institutions is herein referred as “payment server”.

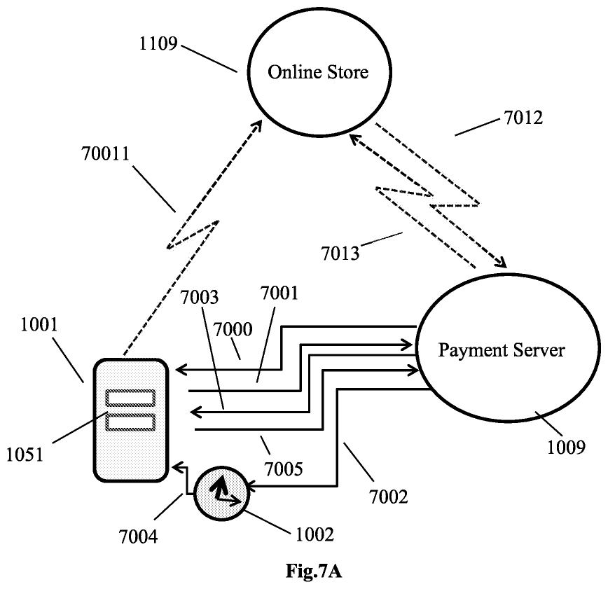

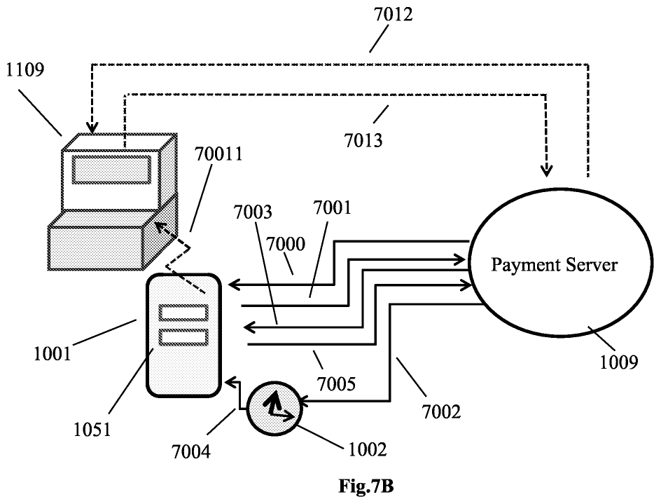

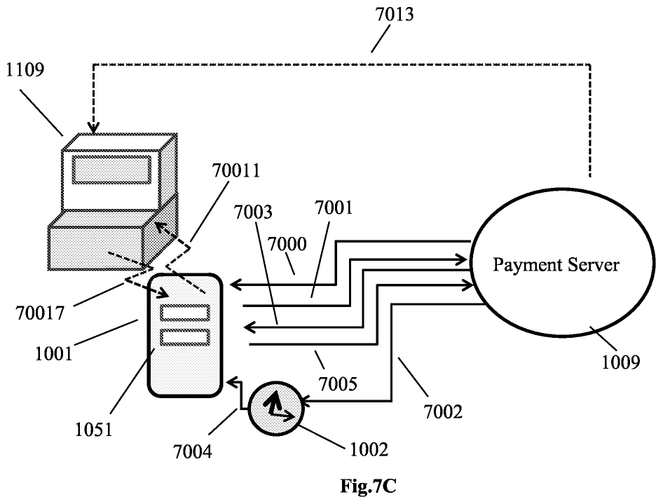

The authentication system/procedure of the invention may be used/combined/integrated with an online payment system to provide a highly secure (online) money transaction/payment. As an example and not by way of limitation, FIGS. 7A to 7C and the corresponding explanations below are used to describe exemplary methods of integration of the authentication system/procedure of the invention within the above-mentioned payment methods/systems.

Exemplary FIG. 7A, is used to describe a system of secure online payment using an authentication procedure/circuit of the invention. In this example the account server 1009 is an online server of a financial/payment company (e.g., the user's bank, a credit card company (e.g., such as Visa or Master Card, Paypal, a server which provides online (e.g., transactions) services to one or more credit card companies, etc.) with/in which a user has an account. Such server may herein be referred to as “payment server”.

In order, for the user, to use the payment service of a payment company, the payment company must have certain information related to the user. Some of said information may be provided during opening an account in a financial/payment company (e.g., a bank) and/or a corresponding payment company (e.g., PayPal).

Preferably, the payment server/financial company/institution (herein may be referred to as a “bank) has the contact information (e.g., email address, telephone number, etc.) of the user. As an example, a bank in which a user has an account may provide a credit/debit card (e.g., for purpose of simplicity, herein may be referred to as “credit card”) to a user. Preferably, said bank has user's contact information such as user's name, user's email address, user's telephone number, user's address, etc. Such information is usually provided by the user to the bank when the user opens an account within the bank. Preferably, the provided credit/debit card has at least on of, an (e.g., identification) number, an expiration date, a security number (e.g., generally, printed in the back of the card), the owner's name, etc. At least some (e.g., preferably, all) of those information are linked to each other and/or to the user's bank account. In addition, when a user may also create an account in an account server of the bank, during which, the user may provide a user's ID (e.g., a “username”), a password, and preferably a telephone number.

Also, when a user opens an account within a payment company server (e.g., PayPal), the user provides some information such as the name of the user, his/her address, a/the credit card information of the user (e.g., number, expiry date, security number, etc.), an email address of the user, a telephone number of the user, a password, etc.

With continuous description of the current invention, as an example, a user desiring to purchase goods from an online store 1109, may first enter into the website of the/an online store using a user's device 1001 through a corresponding connection 70011. After selecting an (e.g., at least one) item (e.g. goods) presented/proposed on the online store webpage, the user may proceed to purchasing the item. If this is the first time that user desires to purchase from said online store, the online store software and/or a correspond/related software may ask for certain information such as user's name, address, email, telephone number, credit card information (e.g., credit card company name, owner name on the credit card, credit card number, expiration date, security number, etc.), etc.

After selecting, by the user, a desired payment method (e.g., credit/debit card, PayPal, Visa, etc.), preferably among a plurality of choices proposed by/on the online store, depending on the selected payment method, the online store, through some channels, may send 7012 some information such as the amount of purchase, the online store identification information, a/the contact information (e.g., the email address credit card information of the user, etc.) of the user, etc. (e.g., herein may be referred to as “payment information”) to the selected/corresponding online payment company/server. Note that, preferably, the user has already/previously created an account within the selected online payment server/company and all of the information (e.g., previously provided, during a corresponding sign-in procedure, to a corresponding payment company (e.g., bank, PayPal, etc.) required by the/a corresponding authentication circuit is already stored in the online store database. Thereafter, different payment processing scenarios may be executed such as the exemplary scenarios described below:
Scenario (a)—According to a first aspect/option, if the selected payment company is an online payment company of category (a) (e.g., PayPal). In this case, the online store server may preferably redirect the user (e.g., the user's device connection) to a/the corresponding (e.g., webpage of the) selected payment server (e.g., in this example, server 1009) (e.g., PayPal). Then, the payment server, may proceed to authentication procedure of the invention using an authentication circuit, as described throughout this patent application. In this example, the communication procedure of the exemplary authentication circuit is demonstrated by continued lines/arrows (e.g., 7000-7005) and the authentication circuit devices include exemplary main device 1001 (e.g. a smartphone, a PC, etc.), the exemplary intermediate device (e.g., a smartwatch) 1002 and the exemplary payment server 1009. As such, as an example and not by way of limitation, after receiving the/a identification information (e.g., email address) of the user from the online store server and matching it to a corresponding entry of the database of the payment server, the payment server may proceed to an authentication procedure. (Note that, alternatively, after redirecting the (e.g., the corresponding device of a/the) user to a corresponding online payment server, the user himself/herself may enter/provide his/her identification information (e.g., the username, email address, etc., that he/she has been previously provided to the online payment store during a sign-in procedure) to the (e.g., log in webpage of the) payment server.)

As such, at least some of the following steps will preferably be provided/executed:
1. Optionally, payment server may send 7000 a request (e.g., webpage) for payment including, for example, (e.g., at least) the name/identification-information of the online store and the amount of purchase to the user's device 1001.
2. Optionally, the user (e.g., through the user's device) may preferably send 7001 a confirmation message to the online server (e.g., by providing a predefined action such as pressing a virtual key/button on the received webpage).
3. Payment server may preferably send 7002 a (e.g., an encrypted) security code, preferably by SMS, to the intermediate (e.g., smartwatch) device 1002 (e.g., which preferably has a SIM card and used cellular communication ability).
4. Optionally/preferably, the payment server sends 7003a (e.g., decrypting) key/code, preferably through Internet, to the main (e.g., smartphone, PC, tablet, etc.) device 1001.
5. Preferably, (e.g., after contacting the controlling server 1019 and getting/acquiring authorization), the intermediate device 1002, preferably using a short-range (e.g., an NFC) communication system, redirects/send 7004 the (e.g., encrypted) security code to the main device 1001.
6. The main device 1001 (e.g., after decrypting the encrypted code) may preferably send 7005 the decrypted security code to the payment server 1009, for completing the authentication procedure. According to one aspect, the decrypted code is sent automatically to the payment server. According to another aspect, the decrypted code is entered/typed manually by a/the user and sent to the payment server.
7. Preferably, after verifying and matching the received security code to the sent security code, based on the information received from the online store 1109, the payment server 1009 (e.g., through a/the corresponding financial institute) (e.g., remotely 7013), through some channels, credits (e.g., send the payment to) a corresponding (e.g. bank) account of the online store 1109 and debits a corresponding (e.g. bank) account of the user.
Scenario (b)—According to a second aspect/option,, the payment company is an online payment company of category (b) (e.g., a user's bank). In this case, the online store server may preferably may request the user's payment information before redirecting the user, through some channels, to the user's/a corresponding online payment server (e.g. the user's bank server). As an example, if the user chooses to pay the selected item/goods by a credit card, the user may fill a (e.g., standard) webpage, corresponding to an online payment through credit/debit card, presented on the online store webpage. After filling the required user's credit card and other information, said information is preferably sent, through some channels, by the online store to a/the corresponding online payment server 1009 of the corresponding credit card and preferably, the user (e.g., user's device connection) is redirected to the corresponding online payment server 1009. Then, an authentication procedure including (e.g., at least some, preferably, all of) the steps (1) to (7) of scenario (a) may be executed.

It must be noted that examples of scenario (a) and (b) are shown exemplary scenarios are described to explain the principles of transfer of funds securely, without the need of a password, by using the authentication system of the invention. Those principles may be applied to any other examples of transferring funds securely, based on in accordance with said principles.

In the examples above, a payment server is described to be the institute/entity (e.g., a bank, PayPal) transferring funds to a supplier on behalf of a user. It is understood that said institute/entity may be of any kind, and user and said supplier may be any type of physical and/or virtual entity.

FIG. 7B shows, as an example, a method/system of payment for goods/items purchased in a physical store (e.g., a supermarket, shoe store, etc.) using the authentication procedure of the invention (e.g., without providing/using a password). As shown in FIG. 7B, the procedure of the payment may, preferably, be similar to that of FIG. 7A, with the difference that, here, the online store webpage/website is replaced by a physical store's point of sale machine/terminal “POS” 1109 (e.g., herein may be referred to as “cashier terminal”).

In the current example, after the value of goods purchased by a user/buyer is calculated (e.g., by the/a cashier terminal, or manually, etc.), the user/buyer may preferably connect 70014 his/her main device 1001 to the cashier terminal 1109 (e.g., or vise versa), preferably, through a near field communication system “NFC” (e.g., or through another short-range communication system). For such purpose, the user may position his/her main device 1001 adjacent/closed to the cashier terminal 1109. After the cashier terminal and user's main device can/do communicate with each other (e.g., automatically, or optionally, upon providing a predefined interaction such as pressing a key on the user's and/or the cashier device) the user's main device 1001 may send, (e.g., through a payment application installed in the user's main device 1001), some information such as the credit card information (e.g., card number, expiry date, the 4-digit security code, etc.) of the user to the point of sale machine/terminal. Thereafter, the cashier terminal 1109 may transmit, through some channel, the/said information and preferably some additional information such as the amount of the purchase and the information corresponding to the physical store to a corresponding payment server 1009 (e.g., the user's bank server). At this time, the payment server may proceed to an authentication procedure of the invention as described throughout this patent application in general and similar to the authentication procedure (e.g., at least some, preferably, all of) the steps (1) to (7) of scenario (a)) explained in regard to purchasing goods in online store as described above. In this example, the communication procedure of the exemplary authentication circuit is demonstrated by continued lines/arrows (e.g., 7000-7005) and the authentication circuit devices include exemplary main device 1001 (e.g. a smartphone, a PC, etc.), the exemplary intermediate device (e.g., a smartwatch) 1002 and the exemplary payment server 1009.

As mentioned before, the authentication procedure/system of the invention can/may be integrated within any payment system. FIG. 7C shows, as an example, a payment system (e.g., for paying for goods purchased in a physical store) similar to that of FIG. 7B with the difference that, here, after calculating the amount of purchase of the user, the physical's store payment terminal (herein may be referred to as “payment terminal”) may preferably provide/send 70017 (e.g., preferably through an NFC communication system, some (e.g., necessary) information such as the amount of purchase of the user and the physical store's (e.g., bank) account information (e.g., transfer information) to the main device 1001 of the user. Then the user's main device may preferably send said information to a payment server by the/a corresponding payment application (e.g., installed and) used by/in the user's device 1001. At this time, the user's payment server may proceed to an authentication procedure similar to that of steps (2) to (7) in relation to FIG. 7A. In this example, the communication procedure of the exemplary authentication circuit is demonstrated by continued lines/arrows (e.g., 7000-7005) and the authentication circuit devices include exemplary main device 1001 (e.g. a smartphone, a PC, etc.), the exemplary intermediate device (e.g., a smartwatch) 1002 and the exemplary payment server 1009.

Note that in the exemplary embodiments of FIGS. 7A to 7C, the user owns/controls the main device 1001 and the intermediate device 1002. In a (e.g., ideal) mobile environment, preferably, the main device is a smartphone (e.g., optionally a tablet, a smartwatch, a laptop, etc.) and the intermediate device is preferably a smartwatch worn on a wrist of the user. Preferably, both, the main device and the intermediate device each have a SIM card (e.g., both have cellular communication ability) with preferably different (e.g. telephone) numbers and NFC communication systems/ability. Optionally, at least the intermediate device has/uses a SIM card (e.g., such device may be a smartwatch which herein may be referred to as a “standalone smartwatch”). Preferably, a (e.g., the encrypted) code sent by a payment server to the intermediate device is sent through SMS using the intermediate device's (telephone) number.

Preferably, (e.g., at least in case of embodiment/example of FIG. 7B), the decrypting key/code is sent (e.g., by the payment server) to the main device 1001 by SMS. In this case, preferably, the payment server should have, both, the telephone number of main device and the telephone number of the intermediate device (e.g., said telephone numbers are preferably provided in advance (e.g., when opening an account) to a corresponding user's financial organization (e.g., user's bank, a corresponding payment server, etc.)). Optionally, the user's bank may provide said information (e.g., in advance or upon a corresponding payment interaction by user with the payment server) to the payment server.

With continuous description of said (e.g., 7A to 7C) embodiments, preferably, an NFC communication system is used between the intermediate device and the main device for forwarding/sending an/the (encrypted) code from the intermediate device and the main device.

Preferably, an NFC communication system/protocol is used between the main device and the payment terminal for transmitting (e.g., in both directions) payment information (e.g., as described throughout the specification related to FIGS. 7B and 7C).

According to a first preferred concept/example, a/the user wearing an/the intermediate device (e.g., a smartwatch) on the wrist of a first hand, may preferably hold the main device in the same hand, for making a payment to an online store. This is because, in this case, intermediate device is very closed to the main device and (e.g., after getting authorization from the control server), the intermediate device can more certainly transmit said code to the main device.

According to a second preferred concept/example, the user wearing the intermediate device (e.g., a smartwatch) on the wrist of a first hand, may preferably hold the main device in the same hand and approach the main device to a/the corresponding payment terminal, for making a payment to a physical store's payment terminal. This is because, in this case, the pair of devices, the/said payment terminal and the main device, are very closed to each other, and the pair of devices, the main device and the intermediate device, are also closed to each, therefore, each of said pair of devices can communicate with each other through their corresponding NFC communication systems.

Preferably, the when an encrypted security code is decrypted on the main device, a manual interaction with said main device (e.g., entering said code manually in a field of an interface displayed on the screen of the main device and/or pressing a send key, etc.) may transmit said/the decrypted security code to the corresponding (e.g., payment) server. Optionally, (e.g., after being decrypted in the main device) said/the decrypted security code may automatically be sent to the corresponding (e.g., payment) server by the main device.

It must be noted that although in the examples of FIGS. 7A to 7C, a payment server is given as example as an account server of the invention participating in an authentication procedure of the invention, said server may of another kind such as server adapted to participate in said authentication of the invention on behalf of and/or in relation to the payment server.

In each of the exemplary FIGS. 7A to 7C, an entire exemplary payment procedure is shown by continued and discontinued communication arrows and a number of the devices and/or servers. Such procedure may herein referred to as “Payment Circuit”. In FIGS. 7A to 7C, each payment circuit includes an exemplary authentication circuit of the invention. (e.g., Note that communication directions of the authentication system/circuit are shown by continuous arrows, and communication directions between a device (e.g., 1001, 1002, 1009) of the authentication system/circuit and a payment server/point of sale machine/terminal are shown by discontinuous arrows.)

It must be noted that other payment circuits including a (e.g., a same or a different) authentication circuit/system of the invention may be considered by people skilled in the art based on the principles described in this patent application. As an example, a payment circuit may include/use multiple (e.g., account) servers using different communication directions and/or methods. Also, an authentication circuit of the invention may include/use multiple devices/servers using different communication directions and/or methods of communication.

An intermediate device may not be a standalone smartwatch (e.g., may not have a cellular communication capability) but rather being a connected smartwatch (e.g., using the cellular communication system of a smartphone to which it is connected for communicating with other devices). In this case, according to one embodiment, said smartphone and said smartwatch may be used, respectively, as the main device and the intermediate device of an authentication system/circuit. In this case, as an example, the/an account server may send the/an encrypted code to said smartphone which then will transmit said security code to said smartwatch. As an example, after receiving the security code from the/an account server, the main device (i.e., the smartphone) may send the security code to the intermediate device (i.e., the connected smartwatch) by any communication means and the intermediate device preferably uses its/a NFC communication system for transmitting back said security code to said main device (i.e., said smartphone). Preferably, (e.g., only) thereafter, the decryption key is sent by the account server to the smartphone.

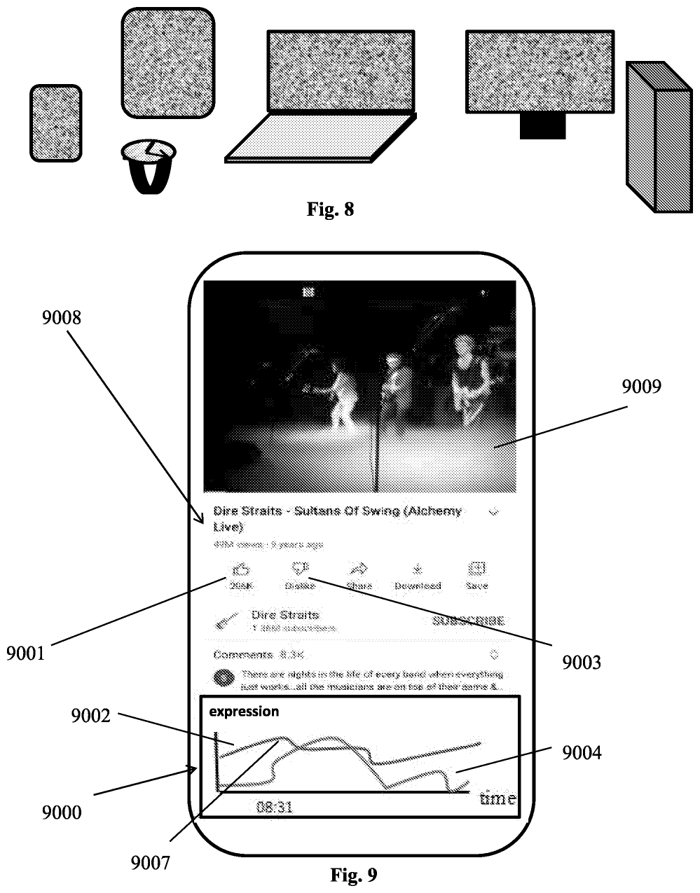

It must be noted that any communication device (e.g., having a processor and an operating system) may be used as the main device, an intermediate device or as additional intermediate device. FIG. 8, shows some examples of such devices (e.g. a desktop, a laptop, a tablet, a smartphone, a smartwatch, etc.) (e.g., Note that, a processor of a device is used for processing at least some (e.g., optionally/preferably, all) of the software (e.g., applications) running within said device). A device may have on or more processors.

According to one aspect, if (e.g., for any reason) the controlling application of the invention is not available on a device of the authentication circuit, said device may use an alternative controlling application for receiving a message from and/or sending a message to another device of the authentication circuit.

Note that a contact information of a device, used by a corresponding authentication system, can/may be any kind such as a telephone number, an email, an IP address, etc.

According to one aspect, the controlling application running within a device within an authentication circuit receiving a security code from another device, may preferably check (e.g. by-using/through a corresponding controlling account) the authenticity of the identification number of said another device in accordance with the corresponding parameter stored within (e.g., a table of) said controlling account.

The authentication system described in this patent application has the advantage of not requiring a password for accessing a desired protected account in a server. This system also eliminates the burden of carrying a list of passwords by a user for accessing a/the desired protected account, and also eliminates/reduces the risk related/caused-by the passwords being lost, hacked or stolen.

It is understood, that, if/when desired, a user can access his/her/a desired protected account in a traditional manner log in procedure by using (e.g., at least) an identification information (e.g., an email) and a password.

Note that, for simplification, some terms used throughout this patent application may have been abbreviated/shortened. As an example,
“within an account server”, may preferably mean, “within and/or controlled-by an account server”
“a user”, may preferably mean, “a user controlling a (corresponding) device”
etc.

Note that security code may be a reference (e.g., a URL) to a security code, In this case, after said reference is received by a predefined device of an authentication circuit, said device may access to/download and use (e.g., send to a next/follwing device, decrypt it, etc.) said security code.

In this patent application the following invention is also described:

During streaming, by a streaming software/application) of at least a portion of a content such as a video and/or an audio within a device, at any arbitrary moment/instance, a user watching and/or listening to said content may be enabled to express his/her emotion in relation to said moment/instance (e.g., within/to said software and/or another software related to the streaming software). Accordingly, when a content is being streamed and viewed by one or more users, a graph of expressions of users over time related to the/a total number of users' expressions may be created. Said graph may be displayed on the screen each time said content is (e.g., accessed to be) viewed and and/or listened (e.g., by a user).

As an example, during streaming/playing a video by a video player application on the screen of a device, an (e.g., one or more) emotion (e.g., “Like”, unlike, etc.) button may be available by a corresponding application to said/a user on the screen. At any arbitrary/desired instance during streaming/playing said video, a user may press said/an emotion (e.g., “Like”) button (e.g., herein may be referred to as “emotion action”). A graph representing the total number of (e.g. same) emotion actions provided by a/total number of users (e.g., expressing their “like” emotion) at different instances during total number of (e.g., entire and/or partial) streaming/watching sessions of a video may, preferably simultaneously to displaying said video, be displayed within an interface (e.g., of said application) on the screen.

As an example, FIG. 9, shows a video player application playing/displaying a video 9009 within an interface 9008. A like button 9001 is available within said interface on the screen. A graph 9002 representing the total number of like actions (e.g., by pressing the like button) provided by a/total number of users (e.g., expressing their “like” emotion) at different instances during total number of (e.g., entire and/or partial) streaming/watching sessions of said video is also displayed within said interface. Said Like actions have been provided, by people who had watched said video 9009, at different instances during the time that at least a portion of said video has been played (e.g., to them). As such, a user opening (e.g., an/the interface of) said video 9009, may (e.g. want to) watch a specific moment/portion of the video in accordance-to/based-on the/said graph shown within said interface (e.g., for example, the user may want to watch the video starting at a specific instance (e.g., 12:31 9007), because the graph 9002 shows that the number of likes is high at said instance).

In the current example, another graph 9004 representing the total number of unlike actions (e.g., by pressing the unlike button 9003) provided by a/total number of users (e.g., expressing their “unlike” emotion) at different instances during total number of (e.g., entire and/or partial) streaming/watching sessions of said video is also displayed within said interface.

According to one embodiment of the invention, upon an interaction such as a taping action on a desired point/instance (e.g., 9007) of a graph (e.g., 9002), sad video may be played starting at said specific instance (e.g., 12:31 9007).

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature. It must be noted, that any of the embodiments, systems, features, means, methods, etc., described in this patent application may be used separately or being combined with any other one or more of other systems, features, means, methods, etc., of described in this patent application.

Examples of embodiments, systems, methods, aspects, and other explanation written thought the specification of this patent application and the corresponding examples of drawings, are used/brought to describe the gist of the invention. it is understood that various examples of embodiments, systems, methods, aspects, and other explanation may be provided/bring-out by those skilled in the art without departing from the spirit of the invention.

1-20. (canceled)

21. An authentication system comprising:
an account within a server, said account being protected by a password;
a first communication device,
a second communication device; and
wherein upon receiving, by the server, a request, from said first device, for accessing said account, the server sends a code to the second device, and
wherein upon receiving, by the second device, said code, from said sever, said code is transmitted from the second device to the first device, and
wherein upon receiving, by the first device, said code, from said second device, said code is transmitted from the first device to the server, and
upon receiving, by the server, said code from the first device, an access to said account is given, by the server, to said first device.

22. The system of claim 21, wherein said code is an encrypted code sent by the server to the second device.

23. The system of claim 22, wherein a decryption key is sent, by the server, to the first device for decrypting said encrypted code.

24. The system of claim 22, wherein said code is decrypted on the first device and thereafter is transmitted from the first device to the server.

25. The system of claim 24, wherein the decrypted code is presented to a user by the first device and thereafter said decrypted code is manually entered by the user in the first device for the transmission to the server.

26. The system of claim 21, wherein said second device is a mobile handset.

27. The system of claim 21, wherein said code is transmitted, form said second device, to the first device through a short-range transmission technology.

28. The system of claim 27, wherein said short-range transmission technology is a near-field communication (NFC) technology.

29. The system of claim 21, wherein said code is transmitted from said second device to the first device through a short-range transmission technology having a range of less than or approximately ten centimeters.

30. The system of claim 21, wherein said a second communication device is at least one communication device.

31. The system of claim 21, wherein said authentication system includes a controlling server having a controlling account for controlling communication behavior of at least said second device within the authentication system.

32. The system of claim 31, wherein upon receiving, by the second device, the code from the server, said code is transmitted from the second device to the first device through a communication technology defined within the controlling account.

33. The system of claim 31, wherein after receiving, by the second device, the code from the server, said code is not transmitted from the second device to the first device based on a parameter defined within the controlling account.

34. The system of claim 31, wherein said controlling account includes a plurality of parameters which are defined by a user controlling said controlling account.

35. The system of claim 21, wherein at least a contact information of the first device, a contact information of the second device, a username and a password are provided to the server for creating said account.

36. The system of claim 21, wherein said decryption key is sent, by the server, to the first device through a short messaging application (SMS).

37. The system of claim 21, wherein an execution of the authentication system is canceled if during transmission of the code from the second device to the first device the transmission is interrupted.

38. The system of claim 21, wherein said a second device is a wearable communication device.

39. The system of claim 21, wherein said a second communication device is a smartwatch.

40. The system of claim 21, wherein upon accessing the account, a function is executed.
